(19) United States
(12) Patent Application Publication
(10) Pub. No.: US 2026/0343537 A1
(43) Pub. Date: Oct. 29, 2026

(54) METHOD AND APPARATUS FOR TYPE-1 HARQ-ACK CODEBOOK DETERMINATION

(71) Applicant: Lenovo (Beijing) Limited, Beijing (CN)

(72) Inventor: Haipeng Lei, Beijing (CN)

(73) Assignee: Lenovo (Beijing) Limited, Beijing (CN)

(21) Appl. No.: 19/111,717

(22) PCT Filed: Nov. 7, 2022
(86) PCT No.: PCT/CN2022/130429

§ 371 Date: Mar. 13, 2025

(51) Int. Cl. H04W 72/1273; H04L 1/1829; H04W 72/232

(52) U.S. Cl. CPC H04W 72/1273; H04L 1/1861; H04W 72/232

(57) ABSTRACT

Embodiments of the present disclosure relate to methods and apparatuses for type-1 (semi-static) hybrid automatic repeat request acknowledgement (HARQ-ACK) codebook determination. According to some embodiments of the disclosure, a UE may: receive a first downlink control information (DCI) format scheduling a first set of physical downlink shared channels (PDSCHs) on a first set of cells of the UE; generate a HARQ-ACK codebook comprising HARQ-ACK feedback associated with candidate PDSCH reception occasions on the first set of cells and HARQ-ACK feedback for the first set of PDSCHs; and transmit the HARQ-ACK codebook.

### TECHNICAL FIELD

Embodiments of the present disclosure generally relate to wireless communication technology, and more particularly to more particularly to type-1 (semi-static) hybrid automatic repeat request acknowledgement (HARQ-ACK) codebook determination.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long-term evolution (LTE) systems, LTE-advanced (LTE-A) systems, or LTE-A Pro systems, and fifth generation (5G) systems, which may also be referred to as new radio (NR) systems.

In a wireless communication system, a user equipment (UE) may monitor a physical downlink control channel (PDCCH) in one or more search spaces. The PDCCH may carry downlink control information (DCI), which may schedule uplink channels, such as a physical uplink shared channel (PUSCH), or downlink channels, such as a physical downlink shared channel (PDSCH). In the case that a DCI schedules a PDSCH, the UE may transmit HARQ-ACK feedback (e.g., HARQ-ACK information bit(s)) for the PDSCH through a PUSCH or a physical uplink control channel (PUCCH). For example, the PUCCH may carry a HARQ-ACK codebook including the HARQ-ACK information bit(s) for the PDSCH.

There is a need for handling HARQ-ACK codebook determination in a wireless communication system.

### SUMMARY

Some embodiments of the present disclosure provide a user equipment (UE). The UE may include a transceiver, and a processor coupled to the transceiver. The processor may be configured to: receive a first downlink control information (DCI) format scheduling a first set of physical downlink shared channels (PDSCHs) on a first set of cells of the UE; generate a hybrid automatic repeat request acknowledgement (HARQ-ACK) codebook comprising HARQ-ACK feedback associated with candidate PDSCH reception occasions on the first set of cells and HARQ-ACK feedback for the first set of PDSCHs; and transmit the HARQ-ACK codebook.

In some embodiments of the present disclosure, generating the HARQ-ACK codebook may include generating HARQ-ACK information bits for each cell of the first set of cells and concatenating the generated HARQ-ACK information bits for each cell of the first set of cells in order of associated serving cell index.

In some embodiments of the present disclosure, generating HARQ-ACK information bits for each cell of the first set of cells may include: generating HARQ-ACK information bits for candidate PDSCH reception occasions of the corresponding cell; and generating a HARQ-ACK information bit(s) for a first PDSCH of the first set of PDSCHs received on the corresponding cell and located outside of the candidate PDSCH reception occasions of the corresponding cell.

In some embodiments of the present disclosure, the HARQ-ACK information bits for the candidate PDSCH reception occasions of the corresponding cell and the HARQ-ACK information bit(s) for the first PDSCH are ordered according to PDSCH reception occasions on the corresponding cell.

In some embodiments of the present disclosure, generating HARQ-ACK information bits for each cell of the first set of cells may include: generating HARQ-ACK information bits for candidate PDSCH reception occasions of the corresponding cell; and generating a HARQ-ACK information bit(s) for a first PDSCH which can be potentially scheduled on the corresponding cell by the first DCI format.

In some embodiments of the present disclosure, the HARQ-ACK information bit(s) for the first PDSCH is placed after or before the HARQ-ACK information bits for the candidate PDSCH reception occasions of the corresponding cell. In some embodiments of the present disclosure, the HARQ-ACK information bits for the candidate PDSCH reception occasions of the corresponding cell are arranged according to PDSCH reception occasions on the corresponding cell.

In some embodiments of the present disclosure, in the case that the first PDSCH is actually scheduled on the corresponding cell by the first DCI format, the HARQ-ACK information bit(s) for the first PDSCH is ACK or negative ACK (NACK) dependent on the decoding result of the first PDSCH. In some embodiments of the present disclosure, in the case that the first PDSCH is not scheduled on the corresponding cell by the first DCI format, the HARQ-ACK information bit(s) for the first PDSCH is NACK.

In some embodiments of the present disclosure, the HARQ-ACK codebook may include a first part and a second part, and generating the HARQ-ACK codebook may include: generating the first part including HARQ-ACK information bits for candidate PDSCH reception occasions of each cell of the first set of cells and generating the second part including HARQ-ACK information bits for all cells which can be potentially scheduled by the first DCI format with one PDSCH on each cell.

In some embodiments of the present disclosure, in the case that a cell which can be potentially scheduled by the first DCI format is not included in the first set of cells, a HARQ-ACK information bit(s) in the second part for the cell is negative ACK (NACK). In some embodiments of the present disclosure, HARQ-ACK information bit(s) in the second part for a cell of the first set of cells scheduled by the first DCI format is ACK or NACK.

In some embodiments of the present disclosure, in the case that a second PDSCH of the first set of PDSCHs is scheduled on a cell of the first set of cells and included within candidate PDSCH reception occasions of the cell, the HARQ-ACK information bit(s) for the second PDSCH in the first part for the cell is ACK or negative ACK (NACK) depending on a decoding result of the second PDSCH, or NACK.

In some embodiments of the present disclosure, the HARQ-ACK codebook may include a first part and a second part, and generating the HARQ-ACK codebook may include: generating the first part including HARQ-ACK information bits for candidate PDSCH reception occasions of each cell of the first set of cells and generating the second part including a HARQ-ACK information bit(s) for one or more PDSCHs among the first set of PDSCHs received on one or more cell(s) of the first set of cells and located out of candidate PDSCH reception occasions of the one or more cell(s) of the first set of cells.

In some embodiments of the present disclosure, the HARQ-ACK information bits in the first part for candidate PDSCH reception occasions of each cell of the first set of cells are arranged according to associated candidate PDSCH reception occasions. In some embodiments of the present disclosure, the HARQ-ACK information bit(s) in the second part is arranged according to associated cell indexes.

In some embodiments of the present disclosure, the HARQ-ACK information bit(s) in the second part is arranged firstly according to associated PDSCH starting timing and then according to associated cell indexes.

In some embodiments of the present disclosure, generating the HARQ-ACK codebook may include, for each cell of the first set of cells: generating a first part including HARQ-ACK information bits for candidate PDSCH reception occasions of the corresponding cell; in the case that a first PDSCH of the first set of PDSCHs is received on the corresponding cell and located outside of the candidate PDSCH reception occasions of the corresponding cell, generating a second part including a HARQ-ACK information bit(s) for the first PDSCH; and concatenating the first part and the second part to generate HARQ-ACK feedback for the corresponding cell.

In some embodiments of the present disclosure, the HARQ-ACK information bits for each cell of the first set of cells are arranged according to associated serving cell indices.

In some embodiments of the present disclosure, the processor is further configured to receive a second DCI format scheduling a second set of PDSCHs on a second set of cells of the UE, wherein HARQ-ACK feedback for the second set of PDSCHs is to be multiplexed in the HARQ-ACK codebook.

In some embodiments of the present disclosure, each of the first and second sets of cells is a subset of a respective set of cells configured for multi-cell scheduling, or is a subset of the same set of cells configured for multi-cell scheduling.

In some embodiments of the present disclosure, generating the HARQ-ACK codebook may include generating HARQ-ACK feedback for each cell of the first and second sets of cells, which may include: generating HARQ-ACK information bits for candidate PDSCH reception occasions of a corresponding cell of the first and second sets of cells; and generating a HARQ-ACK information bit(s) for a first PDSCH received on the corresponding cell and located outside of the candidate PDSCH reception occasions of the corresponding cell.

In some embodiments of the present disclosure, generating the HARQ-ACK codebook may include generating HARQ-ACK feedback for each cell of the first and second sets of cells, which may include: generating HARQ-ACK information bits for candidate PDSCH reception occasions of a corresponding cell of the first and second sets of cells; and generating a HARQ-ACK information bit(s) for a first PDSCH which can be potentially scheduled on the corresponding cell by the first DCI format or the second DCI format.

In some embodiments of the present disclosure, the HARQ-ACK codebook may include a first part and a second part; and generating the HARQ-ACK codebook may include: generating the first part including HARQ-ACK information bits for candidate PDSCH reception occasions of each cell of the first and second sets of cells and generating the second part including HARQ-ACK information bits for all cells which can be potentially scheduled by the first DCI format and the second DCI format with one PDSCH on each cell.

In some embodiments of the present disclosure, the HARQ-ACK information bits in the second part are arranged according to cell indexes of the first and second sets of cells. In some embodiments of the present disclosure, the HARQ-ACK information bits in the second part are arranged firstly according to associated cell set indexes and then according to associated serving cell indexes within a corresponding set of the first and second sets of cells.

In some embodiments of the present disclosure, the HARQ-ACK codebook may include a first part including HARQ-ACK information bits for candidate PDSCH reception occasions of each cell of the first and second sets of cells, and a second part including a HARQ-ACK information bit(s) for one or more PDSCHs among the first set and second sets of PDSCHs received on one or more cell(s) of the first and second sets of cells and located out of candidate PDSCH reception occasions of the one or more cell(s) of the first second sets of cells.

In some embodiments of the present disclosure, generating the HARQ-ACK codebook may include generating HARQ-ACK feedback for each cell of the first and second sets of cells, which may include: a first part including HARQ-ACK information bits for candidate PDSCH reception occasions of a corresponding cell of the first and second sets of cells; and a second part including a HARQ-ACK information bit(s) for a first PDSCH of the first and second sets of PDSCHs in response to the first PDSCH being received on the corresponding cell and located outside of the candidate PDSCH reception occasions of the corresponding cell.

In some embodiments of the present disclosure, the first DCI format includes an indicator indicating the same slot level offset for each of the first set of PDSCHs with reference to the slot where the first DCI format is received, and the HARQ-ACK feedback for the first set of PDSCHs is included in the HARQ-ACK feedback associated with the candidate PDSCH reception occasions on the first set of cells.

In some embodiments of the present disclosure, the first DCI format includes a first indicator indicating separate slot level offset for each of the first set of PDSCHs with reference to the slot where the first DCI format is received, and a second indicator indicating the slot where the HARQ-ACK codebook is transmitted with the restriction that the first set of PDSCHs is included in the candidate PDSCH reception occasions on associated cells of the first set of cells, and the HARQ-ACK feedback for the first set of PDSCHs is included in the HARQ-ACK feedback associated with candidate PDSCH reception occasions on the first set of cells.

Some embodiments of the present disclosure provide a base station (BS). The BS may include a transceiver, and a processor coupled to the transceiver. The processor may be configured to: transmit, to a user equipment (UE), a first downlink control information (DCI) format scheduling a first set of physical downlink shared channels (PDSCHs) on a first set of cells of the UE; and receive, from the UE, a hybrid automatic repeat request acknowledgement (HARQ-ACK) codebook including HARQ-ACK feedback associated with candidate PDSCH reception occasions on the first set of cells and HARQ-ACK feedback for the first set of PDSCHs.

In some embodiments of the present disclosure, the HARQ-ACK codebook may include: HARQ-ACK information bits for each cell of the first set of cells which are ordered according to associated serving cell index.

In some embodiments of the present disclosure, the HARQ-ACK information bits for each cell of the first set of cells may include: HARQ-ACK information bits for candidate PDSCH reception occasions of a corresponding cell; and a HARQ-ACK information bit(s) for a first PDSCH of the first set of PDSCHs transmitted on the corresponding cell and located outside of the candidate PDSCH reception occasions of the corresponding cell.

In some embodiments of the present disclosure, the HARQ-ACK information bits for the candidate PDSCH reception occasions of the corresponding cell and the HARQ-ACK information bit(s) for the first PDSCH are ordered according to PDSCH reception occasions on the corresponding cell.

In some embodiments of the present disclosure, the HARQ-ACK information bits for each cell of the first set of cells may include: HARQ-ACK information bits for candidate PDSCH reception occasions of the corresponding cell; and a HARQ-ACK information bit(s) for a first PDSCH which can be potentially scheduled on the corresponding cell by the first DCI format.

In some embodiments of the present disclosure, the HARQ-ACK information bit(s) for the first PDSCH is placed after or before the HARQ-ACK information bits for the candidate PDSCH reception occasions of the corresponding cell; and wherein the HARQ-ACK information bits for the candidate PDSCH reception occasions of the corresponding cell are arranged according to PDSCH reception occasions on the corresponding cell.

In some embodiments of the present disclosure, in the case that the first PDSCH is actually scheduled on the corresponding cell by the first DCI format, the HARQ-ACK information bit(s) for the first PDSCH is ACK or negative ACK (NACK) dependent on the decoding result of the first PDSCH. In some embodiments of the present disclosure, in the case that the first PDSCH is not scheduled on the corresponding cell by the first DCI format, the HARQ-ACK information bit(s) for the first PDSCH is NACK.

In some embodiments of the present disclosure, the HARQ-ACK codebook may include a first part and a second part, the first part may include HARQ-ACK information bits for candidate PDSCH reception occasions of each cell of the first set of cells, and the second part may include HARQ-ACK information bits for all cells which can be potentially scheduled by the first DCI format with one PDSCH on each cell.

In some embodiments of the present disclosure, in the case that a cell which can be potentially scheduled by the first DCI format is not included in the first set of cells, a HARQ-ACK information bit(s) in the second part for the cell is negative ACK (NACK); and HARQ-ACK information bit(s) in the second part for a cell of the first set of cells scheduled by the first DCI format is ACK or NACK.

In some embodiments of the present disclosure, in the case that a second PDSCH of the first set of PDSCHs is scheduled on a cell of the first set of cells and included within candidate PDSCH reception occasions of the cell, the HARQ-ACK information bit(s) for the second PDSCH in the first part for the cell is ACK or negative ACK (NACK) depending on a decoding result of the second PDSCH, or NACK.

In some embodiments of the present disclosure, the HARQ-ACK codebook may include a first part and a second part, the first part may include HARQ-ACK information bits for candidate PDSCH reception occasions of each cell of the first set of cells, and the second part may include a HARQ-ACK information bit(s) for one or more PDSCHs among the first set of PDSCHs transmitted on one or more cell(s) of the first set of cells and located out of candidate PDSCH reception occasions of the one or more cell(s) of the first set of cells.

In some embodiments of the present disclosure, the HARQ-ACK information bits in the first part for candidate PDSCH reception occasions of each cell of the first set of cells are arranged according to associated candidate PDSCH reception occasions. In some embodiments of the present disclosure, the HARQ-ACK information bit(s) in the second part is arranged according to associated cell indexes.

In some embodiments of the present disclosure, the HARQ-ACK information bit(s) in the second part is arranged firstly according to associated PDSCH starting timing and then according to associated cell indexes.

In some embodiments of the present disclosure, the HARQ-ACK codebook may include: for each cell of the first set of cells, a first part including HARQ-ACK information bits for candidate PDSCH reception occasions of the corresponding cell; and a second part including a HARQ-ACK information bit(s) for a first PDSCH of the first set of PDSCHs in response to the first PDSCH being transmitted on the corresponding cell and located outside of the candidate PDSCH reception occasions of the corresponding cell.

In some embodiments of the present disclosure, the HARQ-ACK information bits for each cell of the first set of cells are arranged according to associated serving cell indices.

In some embodiments of the present disclosure, the processor is further configured to transmit, to the UE, a second DCI format scheduling a second set of PDSCHs on a second set of cells of the UE, wherein HARQ-ACK feedback for the second set of PDSCHs is to be multiplexed in the HARQ-ACK codebook.

In some embodiments of the present disclosure, each of the first and second sets of cells is a subset of a respective set of cells configured for multi-cell scheduling, or is a subset of the same set of cells configured for multi-cell scheduling.

In some embodiments of the present disclosure, the HARQ-ACK codebook may include HARQ-ACK feedback for each cell of the first and second sets of cells, which may include: HARQ-ACK information bits for candidate PDSCH reception occasions of a corresponding cell of the first and second sets of cells; and a HARQ-ACK information bit(s) for a first PDSCH transmitted on the corresponding cell and located outside of the candidate PDSCH reception occasions of the corresponding cell.

In some embodiments of the present disclosure, the HARQ-ACK codebook may include HARQ-ACK feedback for each cell of the first and second sets of cells, which may include: HARQ-ACK information bits for candidate PDSCH reception occasions of a corresponding cell of the first and second sets of cells; and a HARQ-ACK information bit(s) for a first PDSCH which can be potentially scheduled on the corresponding cell by the first DCI format or the second DCI format.

In some embodiments of the present disclosure, the HARQ-ACK codebook may include a first part and a second part, the first part may include HARQ-ACK information bits for candidate PDSCH reception occasions of each cell of the first and second sets of cells, and the second part may include HARQ-ACK information bits for all cells which can be potentially scheduled by the first DCI format and the second DCI format with one PDSCH on each cell.

In some embodiments of the present disclosure, the HARQ-ACK information bits in the second part are arranged according to cell indexes of the first and second sets of cells. In some embodiments of the present disclosure, wherein the HARQ-ACK information bits in the second part are arranged firstly according to associated cell set indexes and then according to associated serving cell indexes within a corresponding set of the first and second sets of cells.

In some embodiments of the present disclosure, the HARQ-ACK codebook may include a first part including HARQ-ACK information bits for candidate PDSCH reception occasions of each cell of the first and second sets of cells, and a second part including HARQ-ACK information bit(s) for one or more PDSCHs among the first set and second sets of PDSCHs transmitted on one or more cell(s) of the first and second sets of cells and located out of candidate PDSCH reception occasions of the one or more cell(s) of the first second sets of cells.

In some embodiments of the present disclosure, the HARQ-ACK codebook may include HARQ-ACK feedback for each cell of the first and second sets of cells, which may include: a first part including HARQ-ACK information bits for candidate PDSCH reception occasions of a corresponding cell of the first and second sets of cells; and a second part including a HARQ-ACK information bit(s) for a first PDSCH of the first and second sets of PDSCHs in response to the first PDSCH being transmitted on the corresponding cell and located outside of the candidate PDSCH reception occasions of the corresponding cell.

In some embodiments of the present disclosure, the first DCI format includes an indicator indicating the same slot level offset for each of the first set of PDSCHs with reference to the slot where the first DCI format is transmitted, and the HARQ-ACK feedback for the first set of PDSCHs is included in the HARQ-ACK feedback associated with the candidate PDSCH reception occasions on the first set of cells.

In some embodiments of the present disclosure, the first DCI format includes a first indicator indicating separate slot level offset for each of the first set of PDSCHs with reference to the slot where the first DCI format is transmitted and a second indicator indicating the slot where the HARQ-ACK codebook is transmitted with the restriction that the first set of PDSCHs is included in the candidate PDSCH reception occasions on associated cells of the first set of cells, and the HARQ-ACK feedback for the first set of PDSCHs is included in the HARQ-ACK feedback associated with candidate PDSCH reception occasions on the first set of cells.

Some embodiments of the present disclosure provide a method performed by a user equipment (UE). The method may include: receiving a first downlink control information (DCI) format scheduling a first set of physical downlink shared channels (PDSCHs) on a first set of cells of the UE; generating a hybrid automatic repeat request acknowledgement (HARQ-ACK) codebook comprising HARQ-ACK feedback associated with candidate PDSCH reception occasions on the first set of cells and HARQ-ACK feedback for the first set of PDSCHs; and transmitting the HARQ-ACK codebook.

Some embodiments of the present disclosure provide a method performed by a base station (BS). The method may include: transmitting, to a user equipment (UE), a first downlink control information (DCI) format scheduling a first set of physical downlink shared channels (PDSCHs) on a first set of cells of the UE; and receiving, from the UE, a hybrid automatic repeat request acknowledgement (HARQ-ACK) codebook comprising HARQ-ACK feedback associated with candidate PDSCH reception occasions on the first set of cells and HARQ-ACK feedback for the first set of PDSCHs.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a schematic diagram of PDSCH transmissions in accordance with some embodiments of the present disclosure;

FIG. 3 illustrates a flow chart of an exemplary procedure of wireless communications in accordance with some embodiments of the present disclosure;

FIGS. 4 and 5 illustrate schematic diagrams of HARQ-ACK codebook determination in accordance with some embodiments of the present disclosure;

FIG. 6 illustrates a schematic diagram of PDSCH transmissions in accordance with some embodiments of the present disclosure;

FIGS. 7-9 illustrate schematic diagrams of HARQ-ACK codebook determination in accordance with some embodiments of the present disclosure;

FIG. 10 illustrates a schematic diagram of PDSCH transmissions in accordance with some embodiments of the present disclosure;

FIG. 11 illustrate a schematic diagram of HARQ-ACK codebook determination in accordance with some embodiments of the present disclosure;

FIG. 12 illustrates a flow chart of an exemplary procedure of wireless communications in accordance with some embodiments of the present disclosure; and

FIG. 13 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

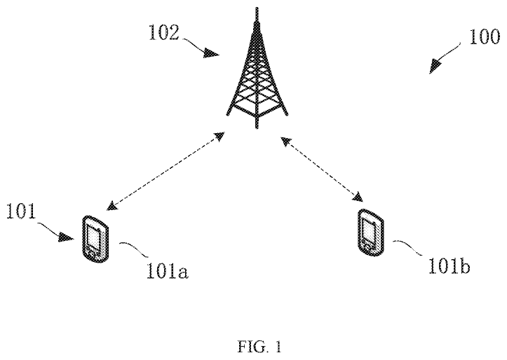

FIG. 1 illustrates a schematic diagram of wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographical region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

A plurality of types of HARQ-ACK codebooks, including for example, a Type-1 HARQ-ACK codebook (also referred to as “semi-static HARQ-ACK codebook”), may be defined for HARQ-ACK multiplexing for multiple received PDSCHs. The definition of the Type-1 HARQ-ACK codebook is specified in 3GPP specifications.

For example, in some embodiments of the present disclosure, the size of a Type-1 HARQ-ACK codebook (e.g., the number of HARQ-ACK information bits included therein) may be independent of the actual scheduling situation. For instance, the number of HARQ-ACK information bits may be determined based on a list of parameters, including, for example, PDSCH-to-HARQ timing values (also referred to as “HARQ-ACK feedback timing set” or “K1 set”), the maximum number of code block groups (CBGs) per transport block (TB) and the number of configured component carriers (CCs), and/or other(s). The K1 set may be configured to a UE via an RRC signaling message or predefined in a standard(s). For example, a UE may determine a time for transmitting a Type-1 HARQ-ACK codebook based on a PDSCH-to-HARQ_feedback timing indicator (hereinafter, “k1”) in a scheduling DCI format, and determine candidate PDSCH reception occasions based on the time for transmitting the codebook and the K1 set. The codebook may include HARQ-ACK information bits for these candidate PDSCH reception occasions, regardless of whether a PDSCH is actually scheduled within a candidate PDSCH reception occasion.

A communication technology (e.g., NR) may support a wide range of spectrums in different frequency ranges. For example, in the market for 5G Advanced, it is expected that the availability of the spectrum will be increased, which is possibly due to re-farming the bands originally used for previous cellular generation networks. For example, for some low frequency bands of frequency range 1 (FR1), the available spectrum bands tend to be more fragmented and scattered with a narrower bandwidth. In addition, for bands of frequency range 2 (FR2) and some bands of FR1, the available spectrum may be wider such that an intra-band multi-carrier operation is necessary.

To meet different spectrum needs, it is important to ensure that these fragmented or scattered spectrum bands or spectrums with wider bandwidth are utilized in a more spectrum and power efficient and flexible manner, thereby providing higher throughput and decent coverage in the network.

For example, one motivation is to increase spectrum/power efficiency and flexibility on scheduling data over multiple cells including intra-band cells and inter-band cells. In some examples, scheduling mechanisms may only allow scheduling a single PUSCH or PDSCH on a single cell per a scheduling DCI. As more scattered spectrum bands or spectrums with wider bandwidth become available, it is advisable to allow simultaneous scheduling of multiple cells. To reduce control overhead, it is beneficial to extend from single-cell scheduling to multi-cell PUSCH/PDSCH scheduling with a single scheduling DCI. For example, a single DCI may schedule multiple PDSCHs or PUSCHs on multiple carriers configured to the UE, which referred to as multi-cell or multi-carrier scheduling in the context of the present disclosure. Meanwhile, a tradeoff between signaling overhead reduction and scheduling restriction may have to be taken into account. A communication system (e.g., NR) may be designed to support a maximum of 16 component carriers (CCs) in the case of carrier aggregation (CA) or a maximum of 32 CCs in the case of dual connectivity (DC).

In the context of the present disclosure, for simplicity, a DCI format scheduling multiple PUSCHs on multiple cells is referred to as DCI format 0_X, and a DCI format scheduling multiple PDSCHs on multiple cells is referred to as DCI format 1_X. In some embodiments of the present disclosure, a DCI format 0_X/1_X may schedule a single PDSCH per cell.

In some embodiments of the present disclosure, when a DCI format 0_X/1_X is transmitted for co-scheduling multiple PUSCHs/PDSCHs on multiple cells, a single time domain resource allocation (TDRA) field in the DCI format 0_X/1_X may indicate one row of a TDRA table where each row of the TDRA table is configured with a separate start and length indication value (SLIV), mapping type, and scheduling offset (e.g., K0/K2 as specified in 3GPP specifications) for each of co-scheduled PUSCHs/PDSCHs.

In some embodiments of the present disclosure, for determining the timing of a PUCCH carrying HARQ-ACK information corresponding to a set of co-scheduled PDSCHs by a DCI format 1_X, the reference PDSCH is the PDSCH ending last as indicated in the DCI format 1_X among the set of co-scheduled PDSCHs.

Hence, for a DCI format 1_X co-scheduling a set of cells and with a TDRA field indicates the separate K0 value for each of co-scheduled PDSCHs, when the PDSCH ending last as indicated in the DCI format 1_X among the co-scheduled PDSCHs is used as the reference PDSCH for determining the timing of a PUCCH carrying HARQ-ACK information corresponding to the set of co-scheduled PDSCHs by the DCI format 1_X, since the k1 value indicated by the PDSCH-to-HARQ_feedback timing indicator field in the DCI format 1_X is associated with the reference PDSCH among the co-scheduled PDSCHs, the co-scheduled PDSCHs on a non-reference cell may be outside of the candidate PDSCH reception occasions determined by the respective K1 set of the non-reference cell, where the reference cell is defined as the cell where the reference PDSCH is transmitted. Thus, the corresponding HARQ-ACK information for those PDSCHs outside of candidate PDSCH reception occasions cannot be reported in a Type-1 HARQ-ACK codebook.

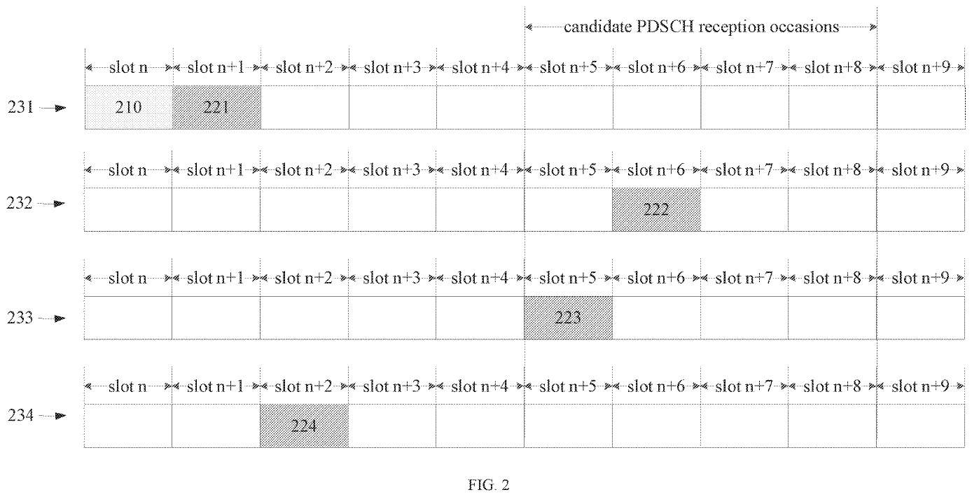

FIG. 2 illustrates a schematic diagram of PDSCH transmissions in accordance with some embodiments of the present disclosure.

Referring to FIG. 2, a plurality of CCs (e.g., including but not limited to CCs 231 to 234 in FIG. 2) may be configured for a UE. It should be understood that the sub-carrier spacings (SCSs) of the carriers configured for a UE may be the same or different. Each of the plurality of CCs may correspond to a respective cell (e.g., serving cell) or carrier of the UE. Each carrier (serving cell) may be associated with a (serving) cell index.

In FIG. 2, a BS may transmit, to a UE, DCI 210 on CC 231 in slot n. It is assumed that DCI 210 co-schedules four cells, i.e., CCs 231 to 234. For simplicity, it is assumed that the serving cell indices of CCs 231 to 234 are: CC 231<CC 232<CC 233<CC 234. DCI 210 may indicate a specific row of TDRA table. It is assumed that the specific row indicates the K0 values of {1, 6, 5, 2}. Based on the indicated K0 values, a UE can determine that DCI 210 schedules PDSCH 221 on CC 231 in slot n+1, PDSCH 222 on CC 232 in slot n+6, PDSCH 223 on CC 233 in slot n+5, and PDSCH 224 on CC 234 in slot n+2. PDSCH 222 is used as the reference PDSCH since it is the latest PDSCH among 4 co-scheduled PDSCHs and cell 232 is regarded as the reference cell. It is assumed that the PDSCH-to-HARQ_feedback timing indicator field in DCI 210 indicates a k1 value of 3, then a PUCCH carrying HARQ-ACK feedback for the 4 co-scheduled PDSCHs is to be transmitted in slot n+9 (i.e., (slot n+6)+3 slot)).

Assuming that K1 set is {1, 2, 3, 4} for each of CCs 231-234, with reference to slot n+9, the candidate PDSCH reception occasions on each cell is determined in slots n+5 to n+8 according to the reverse order of k1 values in the K1 set (e.g., (slot n+9)−4, (slot n+9)−3, (slot n+9)−2, and (slot n+9)−1). As shown in FIG. 2, PDSCH 221 on CC 231 and PDSCH 224 on CC 234 are not included in the range of candidate PDSCH reception occasions on respective cells. In that sense, the Type-1 HARQ-ACK codebook would not include HARQ-ACK information bits for PDSCH 221 and PDSCH 224.

Embodiments of the present disclosure provide solutions for Type-1 HARQ-ACK codebook determination that can solve at least the above issues. For example, embodiments of the present disclosure provide solutions for including the HARQ-ACK information bit(s) for a PDSCH located outside of the candidate PDSCH reception occasions in the HARQ-ACK codebook. For example, embodiments of the present disclosure provide solutions for avoiding the scenario where a PDSCH scheduled by a DCI format is located outside of the candidate PDSCH reception occasions. More details on the embodiments of the present disclosure will be illustrated in the following text in combination with the appended drawings.

FIG. 3 illustrates a flow chart of an exemplary procedure 300 for wireless communications in accordance with some embodiments of the present disclosure. Details described in all of the foregoing embodiments of the present disclosure are applicable for the embodiments shown in FIG. 3. In some examples, the procedure may be performed by a UE, for example, UE 101 in FIG. 1.

In some embodiments of the present disclosure, the UE may be configured with Type-1 HARQ-ACK codebook and a set of cells for multi-cell scheduling using a DCI format 1_X. In some embodiments, all DCI formats 1_X are configured or predefined with the same set of cells for multi-cell scheduling. For example, separate DCI formats 1_X may schedule respective subsets of the same set of cells for multi-cell scheduling. In some embodiments, a plurality of sets of cells may be configured or predefined for multi-cell scheduling. A cell included one cell set of the plurality of sets of cells may not be included in another cell set of the plurality of sets of cells. The single set of cells or the plurality of sets of cells may or may not include all serving cells of the UE. For example, a DCI format 1_X may schedule a subset of cells in a cell set of the plurality of sets of cells and another DCI format 1_X may schedule a subset of cells in another cell set of the plurality of sets of cells.

Referring to FIG. 3, in operation 311, the UE may receive a first DCI format (e.g., a DCI format 1_X as described above) scheduling a first set of PDSCHs on a first set of cells of the UE. In some embodiments, the first set of cells may be a subset of cell set (hereinafter, first cell set) as described above.

A TDRA field in the first DCI format may indicate separate K0 value for each of co-scheduled PDSCHs. The slot where the PUCCH carrying HARQ-ACK feedback for the co-scheduled PDSCHs is transmitted is determined according to the PDSCH which ends last among the co-scheduled PDSCHs as indicated by the TDRA field in the first DCI format and a HARQ-ACK feedback timing value indicated by the PDSCH-to-HARQ_feedback timing indicator field in the first DCI format. Candidate PDSCH reception occasions on each cell of the first set of cells or the first cell set are determined according to the K1 set configured for the corresponding cell and the slot where the PUCCH is transmitted. In some embodiments, separate K1 sets may be configured or predefined for different cells. In some embodiments, the same K1 set may be configured or predefined for different cells.

In operation 313, the UE may generate a HARQ-ACK codebook including HARQ-ACK feedback associated with candidate PDSCH reception occasions on the first set of cells and HARQ-ACK feedback for the first set of PDSCHs. In operation 315, the UE may transmit the HARQ-ACK codebook. For example, the HARQ-ACK codebook in the slot where the PUCCH is transmitted as determined above.

As will be described in the following text, various methods can be employed for determining the HARQ-ACK codebook.

In some embodiments of the present disclosure, solutions for including the HARQ-ACK information bit(s) for a PDSCH located outside of the candidate PDSCH reception occasions in the HARQ-ACK codebook are provided (hereinafter, solution #1). As will be described in the following text, various methods can be employed to achieve solution #1.

### Method #1

In some embodiments of the present disclosure, generating the HARQ-ACK codebook may include generating HARQ-ACK information bits for each cell of the first set of cells and concatenating the generated HARQ-ACK information bits for each cell of the first set of cells in order (e.g., a predefined order such as an ascending order or descending order) of associated serving cell index.

In some embodiments of the present disclosure, generating HARQ-ACK information bits for each cell of the first set of cells may include generating HARQ-ACK information bits for candidate PDSCH reception occasions of the corresponding cell; and generating a HARQ-ACK information bit(s) for a PDSCH (denoted as PDSCH #1A) of the first set of PDSCHs received on the corresponding cell and located outside of the candidate PDSCH reception occasions of the corresponding cell.

In some embodiments, such PDSCH #1A may not exist, for example, when a PDSCH of the first set of PDSCHs scheduled on a specific cell of the first set of cell is located within the corresponding candidate PDSCH reception occasions of the specific cell. Accordingly, HARQ-ACK information bits for the specific cell may only include HARQ-ACK information bits for candidate PDSCH reception occasions of the specific cell.

In some embodiments of the present disclosure, the HARQ-ACK information bits for the candidate PDSCH reception occasions of the corresponding cell and the HARQ-ACK information bit(s) for PDSCH #1A (if any) are ordered according to PDSCH reception occasions on the corresponding cell (e.g., a predefined order thereof, such as an ascending order or descending order of the candidate PDSCH reception occasions on the corresponding cell).

In some examples, when a PDSCH is actually scheduled on a cell within a certain candidate PDSCH reception occasion of the cell, the HARQ-ACK information bit(s) for this candidate PDSCH reception occasion is HARQ-ACK information bit(s) for this PDSCH, that is, ACK or NACK depending on the decoding result of the PDSCH. In some examples, when no PDSCH is actually scheduled on a cell within a certain candidate PDSCH reception occasion of the cell, the HARQ-ACK information bit(s) for this candidate PDSCH reception occasion is NACK.

In some embodiments, the first set of cells may be a subset of a cell set configured for multi-cell scheduling. Generating the HARQ-ACK codebook may include generating HARQ-ACK information bits for each cell of the cell set and concatenating the generated HARQ-ACK information bits for each cell of the cell set in order (e.g., a predefined order such as an ascending order or descending order) of associated serving cell index.

For example, the first DCI format can schedule the cell set but may not actually schedule all cells in the cell set. The HARQ-ACK codebook may include HARQ-ACK information bits for a cell in the cell set that is not actually scheduled by the first DCI format. The HARQ-ACK information bits for this cell may include HARQ-ACK information bits for candidate PDSCH reception occasions of this cell. When none PDSCH is actually scheduled on this cell, the HARQ-ACK information bit(s) for each candidate PDSCH reception occasion of this cell may indicate NACK.

For example, referring back to FIG. 2, the UE may generate a HARQ-ACK codebook to be transmitted in slot n+9. An example HARQ-ACK codebook 450 according to Method #1 is shown in FIG. 4. HARQ-ACK codebook 450 may include HARQ-ACK information bits for each cell of CCs 231-234. For example, as shown in FIG. 4, HARQ-ACK codebook 450 may include HARQ-ACK information bits a1 to a4 which respectively represent HARQ-ACK information bits for CCs 231-234, and are ordered in HARQ-ACK codebook 450 according to an ascending order of the associated cell indexes.

Since PDSCH 221 on CC 231 in FIG. 2 is not included in the range of candidate PDSCH reception occasions of CC 231, HARQ-ACK information bits a1 in FIG. 4 include HARQ-ACK information bits for candidate PDSCH reception occasions of CC 231 and a HARQ-ACK information bit(s) for PDSCH 221, which may be ordered according to the associated candidate PDSCH reception occasions. For example, assuming that the ascending order of candidate PDSCH reception occasions is employed and denoting the HARQ-ACK information bits for the four candidate PDSCH reception occasions of CC 231 in FIG. 2 as a1-1, a1-2, a1-3, and a1-4, and the HARQ-ACK information bit(s) for PDSCH 221 in FIG. 2 as a1-0, HARQ-ACK information bits a1 in FIG. 4 may be denoted as {a1-0, a1-1, a1-2, a1-3, a1-4}. In some examples, a1-1, a1-2, a1-3, and a1-4 may be NACK when no PDSCH is actually scheduled on the corresponding candidate PDSCH reception occasions.

Since PDSCH 222 on CC 232 in FIG. 2 is included in the range of candidate PDSCH reception occasions of CC 232, HARQ-ACK information bits a2 in FIG. 4 include HARQ-ACK information bits for candidate PDSCH reception occasions of CC 232, wherein the HARQ-ACK information bit(s) for the candidate PDSCH reception occasion of CC 232 in slot n+6 in FIG. 2 refers to the HARQ-ACK information bit(s) for PDSCH 222. In some examples, denoting the HARQ-ACK information bits for candidate PDSCH reception occasions in slots n+5, n+7, and n+8 of CC 231 in FIG. 2 as a2-1, a2-3, and a2-4, and the HARQ-ACK information bit(s) for PDSCH 222 in FIG. 2 as a2-0, HARQ-ACK information bits a2 in FIG. 4 may be denoted as {a2-1, a2-0, a2-3, a2-4}. In some examples, a2-1, a2-3, and a2-4 may be NACK when no PDSCH is actually scheduled on the corresponding candidate PDSCH reception occasions.

Since PDSCH 223 on CC 233 in FIG. 2 is included in the range of candidate PDSCH reception occasions of CC 233, HARQ-ACK information bits a3 in FIG. 4 include HARQ-ACK information bits for candidate PDSCH reception occasions of CC 233, wherein the HARQ-ACK information bit(s) for the candidate PDSCH reception occasion of CC 233 in slot n+5 in FIG. 2 refers to the HARQ-ACK information bit(s) for PDSCH 223. In some examples, denoting the HARQ-ACK information bits for candidate PDSCH reception occasions in slots n+6, n+7, and n+8 of CC 231 in FIG. 2 as a3-2, a3-3, and a3-4, and the HARQ-ACK information bit(s) for PDSCH 223 in FIG. 2 as a3-0, HARQ-ACK information bits a3 in FIG. 4 may be denoted as {a3-0, a3-2, a3-3, a3-4}. In some examples, a3-2, a3-3, and a3-4 may be NACK when no PDSCH is actually scheduled on the corresponding candidate PDSCH reception occasions.

Since PDSCH 224 on CC 234 in FIG. 2 is not included in the range of candidate PDSCH reception occasions of CC 234, HARQ-ACK information bits a4 in FIG. 4 include HARQ-ACK information bits for candidate PDSCH reception occasions of CC 234 and a HARQ-ACK information bit(s) for PDSCH 224, which may be ordered according to the ascending order of candidate PDSCH reception occasions as assumed above. Denoting the HARQ-ACK information bits for the four candidate PDSCH reception occasions of CC 234 in FIG. 2 as a4-1, a4-2, a4-3, and a4-4, and the HARQ-ACK information bit(s) for PDSCH 224 in FIG. 2 as a4-0, HARQ-ACK information bits a4 in FIG. 4 may be denoted as {a4-0, a4-1, a4-2, a4-3, a4-4}. In some examples, a4-1, a4-2, a4-3, and a4-4 may be NACK when no PDSCH is actually scheduled on the corresponding candidate PDSCH reception occasions.

From the perspective of a UE, the following steps may be performed for generating a Type-1 HARQ-ACK codebook according to Method #1:
(1-1) A UE checks the K0 value for each of co-scheduled PDSCHs as indicated by the TDRA field and finds out the reference PDSCH which ends last among the co-scheduled PDSCHs.
(1-2) The UE determines the slot where the PUCCH carrying HARQ-ACK feedback for the co-scheduled PDSCHs is transmitted.
(1-3) The UE identifies the candidate PDSCH reception occasions for each cell of the co-scheduled cells (or configured cell set) according to the respective K1 set of each cell of the co-scheduled cells (or configured cell set) and the slot where the PUCCH is transmitted.
(1-4) For each cell of the co-scheduled cells (or configured cell set),
   the UE generates HARQ-ACK information bits for each candidate PDSCH reception occasion on the cell;
   the UE checks whether there is one or multiple PDSCHs which are scheduled by a multi-cell scheduling DCI format(s) (e.g., DCI format 1_X or the first DCI format) and located outside of the candidate PDSCH reception occasions on the cell;
   if only a single PDSCH scheduled by a multi-cell scheduling DCI format is outside of the candidate PDSCH reception occasions on the cell, the UE generates HARQ-ACK information bit(s) for the single PDSCH; and
   if there are multiple PDSCHs scheduled by multiple multi-cell scheduling DCI formats outside of the candidate PDSCH reception occasions on the cell, UE generates HARQ-ACK information bit(s) for the multiple PDSCHs.
(1-5) The UE concatenates HARQ-ACK information bits for each cell of the co-scheduled cells (or configured cell set) as the Type-1 HARQ-ACK codebook for transmitting on the PUCCH.

From the perspective of a BS, it may transmit, to the UE, a DCI format scheduling a plurality of PDSCHs, and may receive, from the UE, a Type-1 HARQ-ACK codebook as generated above.

### Method #2

In some embodiments of the present disclosure, generating the HARQ-ACK codebook may include generating HARQ-ACK information bits for each cell of the first set of cells and concatenating the generated HARQ-ACK information bits for each cell of the first set of cells in order (e.g., a predefined order such as an ascending order or descending order) of associated serving cell index.

In some embodiments of the present disclosure, generating HARQ-ACK information bits for each cell of the first set of cells may include: generating HARQ-ACK information bits for candidate PDSCH reception occasions of the corresponding cell; and generating a HARQ-ACK information bit(s) for a PDSCH (denoted as PDSCH #1B) which can be potentially scheduled on the corresponding cell by the first DCI format.

In some examples, when a PDSCH is actually scheduled on a cell within a certain candidate PDSCH reception occasion of the cell, the HARQ-ACK information bit(s) for this candidate PDSCH reception occasion is HARQ-ACK information bit(s) for this PDSCH, that is, ACK or NACK depending on the decoding result of the PDSCH. In some examples, when no PDSCH is actually scheduled on a cell within a certain candidate PDSCH reception occasion of the cell, the HARQ-ACK information bit(s) for this candidate PDSCH reception occasion is NACK.

In some other examples, the HARQ-ACK information bit(s) for a candidate PDSCH reception occasion is always NACK. For instance, even when a PDSCH is actually scheduled on a cell within a certain candidate PDSCH reception occasion of the cell, the HARQ-ACK information bit(s) for this candidate PDSCH reception occasion is NACK. This is because the HARQ-ACK information bit(s) for this PDSCH within the certain candidate PDSCH reception occasion of the cell can be indicated by HARQ-ACK information bit(s) for PDSCH #1B.

The HARQ-ACK information bit(s) for PDSCH #1B may always be included in the HARQ-ACK information bits for the corresponding cell, regardless of whether a PDSCH is actually scheduled by the first DCI format on the corresponding cell. For example, in the case that the corresponding cell or PDSCH #1B is not scheduled by the first DCI format, a NACK bit(s) may be generated (i.e., the HARQ-ACK information bit(s) for PDSCH #1B is NACK). In the case that the corresponding cell or PDSCH #1B is actually scheduled by the first DCI format, an ACK or NACK bit(s) may be generated depending on the decoding result of PDSCH #1B scheduled on the corresponding cell (i.e., the HARQ-ACK information bit(s) for PDSCH #1B is ACK or NACK).

In some embodiments of the present disclosure, the HARQ-ACK information bits for the candidate PDSCH reception occasions of the corresponding cell are ordered according to PDSCH reception occasions on the corresponding cell (e.g., a predefined order thereof, such as an ascending order or descending order of the candidate PDSCH reception occasions on the corresponding cell). The HARQ-ACK information bit(s) for PDSCH #1B on the corresponding cell is placed after or before the HARQ-ACK information bits for the candidate PDSCH reception occasions of the corresponding cell.

In some embodiments, the first set of cells may be a subset of a cell set configured for multi-cell scheduling. Generating the HARQ-ACK codebook may include generating HARQ-ACK information bits for each cell of the cell set and concatenating the generated HARQ-ACK information bits for each cell of the cell set in order (e.g., a predefined order such as an ascending order or descending order) of associated serving cell index.

For example, the first DCI format can schedule the cell set but may not actually schedule all cells in the cell set. The HARQ-ACK codebook may include HARQ-ACK information bits for a cell in the cell set that is not actually scheduled by the first DCI format. The HARQ-ACK information bits for this cell may include HARQ-ACK information bits for candidate PDSCH reception occasions of this cell and HARQ-ACK information bit(s) for an assumed PDSCH #1B on this cell, all of which may be NACK when none PDSCH is actually scheduled on this cell.

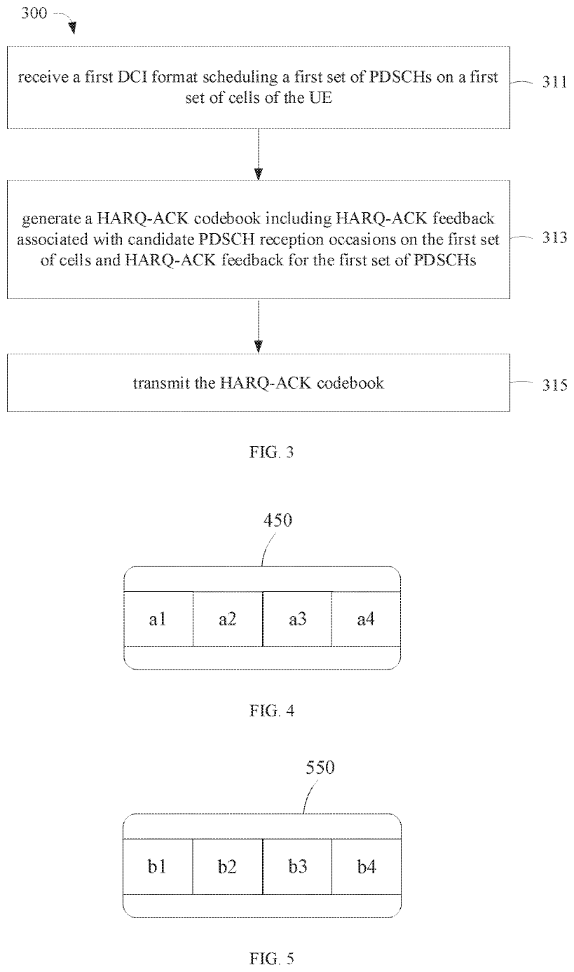

For example, referring back to FIG. 2, the UE may generate a HARQ-ACK codebook to be transmitted in slot n+9. An example HARQ-ACK codebook 550 according to Method #2 is shown in FIG. 5. HARQ-ACK codebook 550 may include HARQ-ACK information bits for each cell of CCs 231-234. For example, as shown in FIG. 5, HARQ-ACK codebook 550 may include HARQ-ACK information bits b1 to b4 which respectively represent HARQ-ACK information bits for CCs 231-234, and are ordered in HARQ-ACK codebook 550 according to an ascending order of the associated cell indexes.

Since PDSCH 221 is scheduled on CC 231 in FIG. 2, HARQ-ACK information bits b1 in FIG. 5 include HARQ-ACK information bits for candidate PDSCH reception occasions of CC 231, which may be ordered according to the associated candidate PDSCH reception occasions, and a HARQ-ACK information bit(s) for PDSCH 221, which may be placed in front of or after the HARQ-ACK information bits for candidate PDSCH reception occasions of CC 231.

For simplicity, it is assumed that for each cell, the ascending order of candidate PDSCH reception occasions is employed, and/or the HARQ-ACK information bit(s) for a potentially scheduled PDSCH is placed in front of the HARQ-ACK information bits for candidate PDSCH reception occasions.

For example, denoting the HARQ-ACK information bits for the four candidate PDSCH reception occasions of CC 231 in FIG. 2 as b1-1, b1-2, b1-3, and b1-4, and the HARQ-ACK information bit(s) for PDSCH 221 in FIG. 2 as b1-0, HARQ-ACK information bits b1 in FIG. 5 may be denoted as {b1-0, b1-1, b1-2, b1-3, b1-4}. In some examples, b1-1, b1-2, b1-3, and b1-4 may be NACK.

Since PDSCH 222 is scheduled on CC 232 in FIG. 2, HARQ-ACK information bits b2 in FIG. 5 include HARQ-ACK information bits for candidate PDSCH reception occasions of CC 232, which may be ordered according to the associated candidate PDSCH reception occasions, and a HARQ-ACK information bit(s) for PDSCH 222, which may be placed in front of (as assumed above) the HARQ-ACK information bits for candidate PDSCH reception occasions of CC 232.

The HARQ-ACK information bit(s) for the candidate PDSCH reception occasion of CC 232 in slot n+6 in FIG. 2 may refer to the HARQ-ACK information bit(s) for PDSCH 222 or always be NACK. In some embodiments, when no PDSCH is actually transmitted in a candidate PDSCH reception occasion of a cell, the HARQ-ACK information bit(s) for this candidate PDSCH reception occasion indicates NACK. For example, denoting the HARQ-ACK information bit(s) for PDSCH 222 in FIG. 2 as b2-0, HARQ-ACK information bits b2 in FIG. 5 may be denoted as {b2-0, NACK, b2-0, NACK, NACK} or {b2-0, NACK, NACK, NACK, NACK}.

Since PDSCH 223 is scheduled on CC 233 in FIG. 2, HARQ-ACK information bits b3 in FIG. 5 include HARQ-ACK information bits for candidate PDSCH reception occasions of CC 233, which may be ordered according to the associated candidate PDSCH reception occasions, and a HARQ-ACK information bit(s) for PDSCH 223, which may be placed in front of (as assumed above) the HARQ-ACK information bits for candidate PDSCH reception occasions of CC 233.

The HARQ-ACK information bit(s) for the candidate PDSCH reception occasion of CC 233 in slot n+5 in FIG. 2 may refer to the HARQ-ACK information bit(s) for PDSCH 223 or always be NACK. In some embodiments, when no PDSCH is actually transmitted in a candidate PDSCH reception occasion of a cell, the HARQ-ACK information bit(s) for this candidate PDSCH reception occasion indicates NACK. For example, denoting the HARQ-ACK information bit(s) for PDSCH 223 in FIG. 2 as b3-0, HARQ-ACK information bits b3 in FIG. 5 may be denoted as {b3-0, b3-0, NACK, NACK, NACK} or {b3-0, NACK, NACK, NACK, NACK}.

Since PDSCH 224 is scheduled on CC 234 in FIG. 2, HARQ-ACK information bits b4 in FIG. 5 include HARQ-ACK information bits for candidate PDSCH reception occasions of CC 234, which may be ordered according to the associated candidate PDSCH reception occasions, and a HARQ-ACK information bit(s) for PDSCH 224, which may be placed in front of (as assumed above) the HARQ-ACK information bits for candidate PDSCH reception occasions of CC 234.

In some embodiments, when no PDSCH is actually transmitted in a candidate PDSCH reception occasion of a cell, the HARQ-ACK information bit(s) for this candidate PDSCH reception occasion indicates NACK. For example, denoting the HARQ-ACK information bit(s) for PDSCH 224 in FIG. 2 as b4-0, HARQ-ACK information bits b4 in FIG. 5 may be denoted as {b4-0, NACK, NACK, NACK, NACK}.

From the perspective of a UE, the following steps may be performed for generating a Type-1 HARQ-ACK codebook according to Method #2:
(2-1) A UE checks the K0 value for each of co-scheduled PDSCHs as indicated by the TDRA field and finds out the reference PDSCH which ends last among the co-scheduled PDSCHs.
(2-2) The UE determines the slot where the PUCCH carrying HARQ-ACK feedback for the co-scheduled PDSCHs is transmitted.
(2-3) The UE identifies the candidate PDSCH reception occasions for each cell of the co-scheduled cells (or configured cell set) according to the respective K1 set of each cell of the co-scheduled cells (or configured cell set) and the slot where the PUCCH is transmitted.
(2-4) For each cell of the co-scheduled cells (or configured cell set),
   the UE generates HARQ-ACK information bits for each candidate PDSCH reception occasion on the cell;
   the UE generates HARQ-ACK information bit(s) for a PDSCH (e.g., PDSCH #1B) which can be potentially scheduled on the cell by a multi-cell DCI format (e.g., DCI format 1_X).
(2-5) The UE concatenates HARQ-ACK information bits for each cell of the co-scheduled cells (or configured cell set) as the Type-1 HARQ-ACK codebook for transmitting on the PUCCH.

From the perspective of a BS, it may transmit, to the UE, a DCI format scheduling a plurality of PDSCHs, and may receive, from the UE, a Type-1 HARQ-ACK codebook as generated above.

### Method #3

In some embodiments of the present disclosure, the HARQ-ACK codebook may include two parts (denoted as part #1C and part #2C for clarity). Generating the HARQ-ACK codebook may include: generating part #1C including HARQ-ACK information bits for candidate PDSCH reception occasions of each cell of the first set of cells and generating part #2C including HARQ-ACK information bits for all cells which can be potentially scheduled by the first DCI format with one PDSCH on each cell.

For part #1C, in some examples, when a PDSCH is actually scheduled on a cell within a certain candidate PDSCH reception occasion of the cell, the HARQ-ACK information bit(s) for this candidate PDSCH reception occasion is HARQ-ACK information bit(s) for this PDSCH, that is, ACK or NACK depending on the decoding result of the PDSCH. For instance, in the case that a PDSCH of the first set of PDSCHs is scheduled on a cell of the first set of cells and included within a candidate PDSCH reception occasion of the cell, the HARQ-ACK information bit(s) for this candidate PDSCH reception occasion in part #1C refers to the HARQ-ACK information bit(s) for this PDSCH. In some examples, when no PDSCH is actually scheduled on a cell within a certain candidate PDSCH reception occasion of the cell, the HARQ-ACK information bit(s) for this candidate PDSCH reception occasion is NACK.

For part #1C, in some other examples, the HARQ-ACK information bit(s) for a candidate PDSCH reception occasion is always NACK. For instance, even when a PDSCH is actually scheduled on a cell within a certain candidate PDSCH reception occasion of the cell, the HARQ-ACK information bit(s) for this candidate PDSCH reception occasion is NACK. For instance, in the case that a PDSCH of the first set of PDSCHs is scheduled on a cell of the first set of cells and included within a candidate PDSCH reception occasion of the cell, the HARQ-ACK information bit(s) for this candidate PDSCH reception occasion in part #1C is NACK. This is because the HARQ-ACK information bit(s) for this actually scheduled PDSCH can be indicated by part #2C.

In some embodiments of the present disclosure, the HARQ-ACK information bits in part #1C may be ordered firstly according to candidate PDSCH reception occasions (e.g., a predefined order such as an ascending order or descending order of the candidate PDSCH reception occasions) for each of the first set of cells and then according to serving cell indexes of the first set of cells (e.g., a predefined order such as an ascending order or descending order of the serving cell indexes).

In some embodiments, the first set of cells may be a subset of a cell set configured for multi-cell scheduling. Generating part #1C may include generating HARQ-ACK information bits for candidate PDSCH reception occasions of each cell of the cell set (which may be ordered according to a predefined order such as an ascending order or descending order of the candidate PDSCH reception occasions of the corresponding cell) and concatenating the generated HARQ-ACK information bits according to associated serving cell indexes (e.g., a predefined order such as an ascending order or descending order of the serving cell indexes of the cell set).

For example, the first DCI format can schedule the cell set but may not actually schedule all cells in the cell set. Part #1C may include HARQ-ACK information bits for candidate PDSCH reception occasions of a cell in the cell set that is not actually scheduled by the first DCI format.

As mentioned before, in the context of the present disclosure, cells that can be potentially scheduled by a multi-cell DCI format may refer to the cells in the corresponding configured cell set. Part #2C may include HARQ-ACK information bits for all cells which can be potentially scheduled by the first DCI format with one PDSCH on each cell, regardless of whether a cell of such cells is actually scheduled by the first DCI format or not.

In some embodiments of the present disclosure, a cell which can be potentially scheduled by the first DCI format is not included in the first set of cells (i.e., not actually scheduled), a HARQ-ACK information bit(s) in part #2C for this cell is NACK. HARQ-ACK information bit(s) in the part #2C for a cell of the first set of cells scheduled by the first DCI format is ACK or NACK, depending on the decoding result of a PDSCH scheduled on this cell.

In some embodiments of the present disclosure, the HARQ-ACK information bits in part #2C may be arranged according to associated cell indexes (e.g., a predefined order such as an ascending order or descending order of the serving cell indexes of the configured cell set).

In some embodiments of the present disclosure, part #1C and part #2C may be arranged in the HARQ-ACK codebook according to a predefined order. For example, part #1C is placed firstly in the HARQ-ACK codebook and followed by part #2C. For example, part #2C is placed firstly in the HARQ-ACK codebook and followed by part #1C.

In some embodiments of present disclosure, when at least one cell of the configured cell set associated with a DCI format 1_X (e.g., the first DCI format) is configured with a maximum of 2 codewords per PDSCH without spatial bundling, the number of HARQ-ACK information bits in part #2C (i.e., the size of part #2C) may be based on (e.g., is equal to) M, where M denotes the maximum number of transport blocks (TBs) which can be co-scheduled by a DCI format 1_X (e.g., the first DCI format) in a PUCCH group for the UE.

In some embodiments of present disclosure, when none cell of the configured cell set is configured with a maximum of 2 codewords per PDSCH, or when one or more cells of the configured cell set are configured with a maximum of 2 codewords per PDSCH and configured with spatial bundling, the number of HARQ-ACK information bits in part #2C (i.e., the size of part #2C) may be based on (e.g., is equal to) N, where N is the maximum number of cells which can be co-scheduled by a DCI format 1_X (e.g., the first DCI format) in the PUCCH group for the UE.

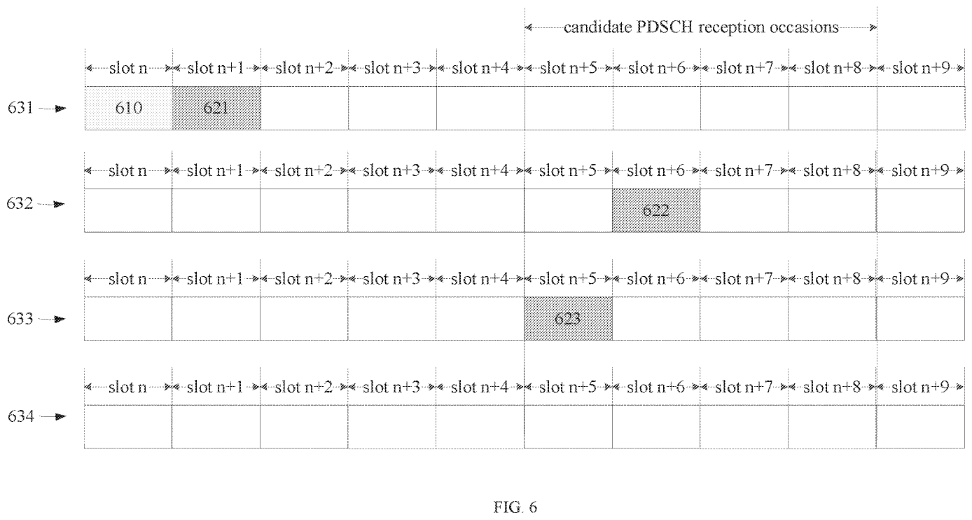

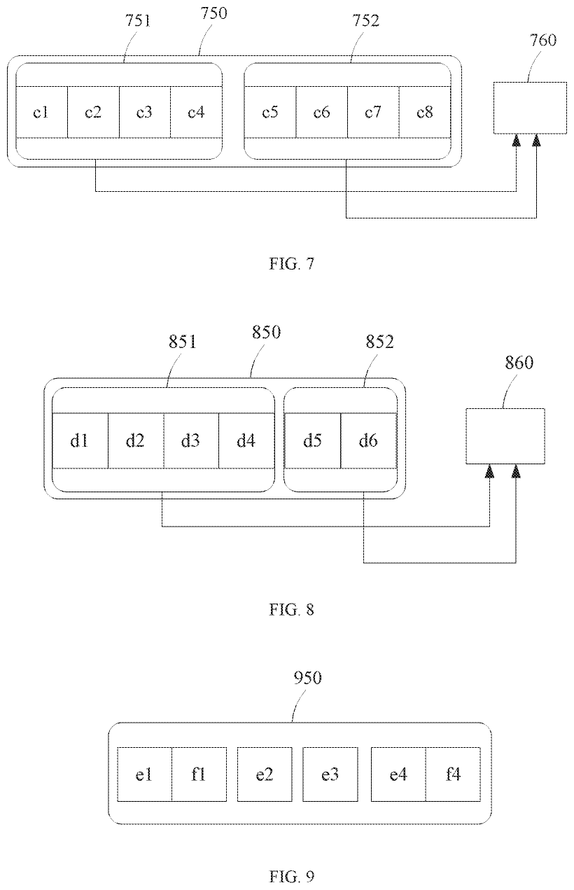

An example of HARQ-ACK codebook determination according to Method #3 is shown in FIGS. 6 and 7.

Referring to FIG. 6, a UE may be configured with a set of cells including CCs 631 to 634 for multi-cell scheduling by a DCI format 1_X. For simplicity, it is assumed that the serving cell indices of CCs 631 to 634 are: CC 631<CC 632<CC 633<CC 634.

The UE may receive, from a BS, DCI 610 on CC 631 in slot n. It is assumed that DCI 610 co-schedules 3 cells, i.e., CCs 631 to 633. DCI 610 may indicate a specific row of TDRA table, which indicates the K0 values of {1, 6, 5, 2}. Based on the indicated K0 values and the number of co-scheduled cells (e.g., assumed as 3), a UE can determine that DCI 610 schedules PDSCH 621 on CC 631 in slot n+1, PDSCH 622 on CC 632 in slot n+6, and PDSCH 623 on CC 633 in slot n+5. PDSCH 622 is used as the reference PDSCH since it is the latest PDSCH among 3 co-scheduled PDSCHs and cell 632 is regarded as the reference cell. It is assumed that the PDSCH-to-HARQ_feedback timing indicator field in DCI 610 indicates a k1 value of 3, then a PUCCH carrying HARQ-ACK feedback for the 3 co-scheduled PDSCHs is to be transmitted in slot n+9 (i.e., (slot n+6)+3 slot)).

Assuming that K1 set is {1, 2, 3, 4} for each of CCs 631-634, with reference to slot n+9, the candidate PDSCH reception occasions on each cell is determined in slots n+5 to n+8 according to the reverse order of k1 values in the K1 set.

The UE may generate HARQ-ACK codebook 750 as shown in FIG. 7 according to Method #3 for transmission in slot n+9 (e.g., on PUCCH 760 as shown in FIG. 7).

As shown in FIG. 7, HARQ-ACK codebook 750 includes part 751 and part 752. Part 751 includes HARQ-ACK information bits for candidate PDSCH reception occasions on each of the configure cell set for multi-cell scheduling. Part 752 includes HARQ-ACK information bits for all cells of the configure cell set with one PDSCH on each cell.

For simplicity, it is assumed that the ascending order of cell indexes is employed. For example, denoting the HARQ-ACK information bits for the candidate PDSCH reception occasions of CCs 631-634 in FIG. 6 respectively as c1 to c4, part 751 in FIG. 7 may be arranged as {c1, c2, c3, c4}. For example, denoting the HARQ-ACK information bits for PDSCHs 621 to 623 in FIG. 6 respectively as c5 to c7 and the HARQ-ACK information bits for a PDSCH potential scheduled on CC 634 in FIG. 6 as c8, part 752 in FIG. 7 may be arranged as {c5, c6, c7, c8}. In some examples, when no PDSCH is actually scheduled on CC 634 in FIG. 6, c8 may indicate NACK.

HARQ-ACK information bits c1 in FIG. 7 include HARQ-ACK information bits for four candidate PDSCH reception occasions of CC 631 in FIG. 6, which may be ordered according to the associated candidate PDSCH reception occasions. Similarly, HARQ-ACK information bits c2, c3, or c4 in FIG. 7 include HARQ-ACK information bits for four candidate PDSCH reception occasions of CC 632, 633, or 634 in FIG. 6, which may be ordered according to the associated candidate PDSCH reception occasions.

For simplicity, it is assumed that for each cell, the ascending order of candidate PDSCH reception occasions is employed.

For example, denoting the HARQ-ACK information bits for the four candidate PDSCH reception occasions of CC 631 in FIG. 6 as c1-1, c1-2, c1-3, and c1-4, HARQ-ACK information bits c1 in FIG. 7 may be denoted as {c1-1, c1-2, c1-3, c1-4}.

In some embodiments, when no PDSCH is actually transmitted in a candidate PDSCH reception occasion of a cell, the HARQ-ACK information bit(s) for this candidate PDSCH reception occasion indicates NACK. For example, c1-1, c1-2, c1-3, and c1-4 may be NACK.

In some embodiments, when a PDSCH is actually transmitted in a candidate PDSCH reception occasion of a cell, the HARQ-ACK information bit(s) for this candidate PDSCH reception occasion refers to the HARQ-ACK information bit(s) for this PDSCH. In some other embodiments, the HARQ-ACK information bit(s) for a candidate PDSCH reception occasion of a cell may always indicate NACK.

For example, the HARQ-ACK information bit(s) for the candidate PDSCH reception occasion of CC 632 in slot n+6 in FIG. 6 may refer to the HARQ-ACK information bit(s) for PDSCH 622 (e.g., c6) since PDSCH 622 is scheduled in slot n+6 on CC 632, or may always be NACK. For example, HARQ-ACK information bits c2 in FIG. 7 may be denoted as {NACK, c6, NACK, NACK} or {NACK, NACK, NACK, NACK}.

Similarly, the HARQ-ACK information bit(s) for the candidate PDSCH reception occasion of CC 633 in slot n+5 in FIG. 6 may refer to the HARQ-ACK information bit(s) for PDSCH 623 (e.g., c7) since PDSCH 623 is scheduled in slot n+5 on CC 633, or may always be NACK. For example, HARQ-ACK information bits c3 in FIG. 7 may be denoted as {c7, NACK, NACK, NACK} or {NACK, NACK, NACK, NACK}.

For example, DCI 610 does not schedule CC 634, HARQ-ACK information bits c4 in FIG. 7 may be denoted as {NACK, NACK, NACK, NACK}.

From the perspective of a UE, the following steps may be performed for generating a Type-1 HARQ-ACK codebook according to Method #3:
(3-1) A UE checks the K0 value for each of co-scheduled PDSCHs as indicated by the TDRA field and finds out the reference PDSCH which ends last among the co-scheduled PDSCHs.
(3-2) The UE determines the slot where the PUCCH carrying HARQ-ACK feedback for the co-scheduled PDSCHs is transmitted.
(3-3) The UE identifies the candidate PDSCH reception occasions for each of the configured cell set according to the respective K1 set of each cell of the configured cell set and the slot where the PUCCH is transmitted.
(3-4) The UE generates part #1C comprising HARQ-ACK information bits for each candidate PDSCH reception occasion for each cell of co-scheduled cells (or configured cell set) and orders the generated HARQ-ACK information bits firstly according to (e.g., in an ascending order of) candidate PDSCH reception occasions for each cell of the co-scheduled cells (or configured cell set) and then according to (e.g., in an ascending order of) serving cell indexes of the co-scheduled cells (or configured cell set).
(3-5) The UE generates part #2C comprising HARQ-ACK information bits for the configured cell set. In one embodiment, the UE orders the HARQ-ACK information bits for the configured cell set according to (e.g., in an ascending order of) serving cell indexes of the configured cell set. In another embodiment, the HARQ-ACK information bits for the configured cell set are ordered according to (e.g., in an ascending order of) PDSCH starting timing, and if there are two or more PDSCHs having the same staring timing, then the HARQ-ACK information bits for the two or more PDSCHs having the same staring timing are ordered according to (e.g., in an ascending order of) associated serving cell indexes.
(3-6) The UE concatenates part #1C and part #2C as the HARQ-ACK codebook for transmitting on the PUCCH.

From the perspective of a BS, it may transmit, to the UE, a DCI format scheduling a plurality of PDSCHs, and may receive, from the UE, a Type-1 HARQ-ACK codebook as generated above.

### Method #4

In some embodiments of the present disclosure, the HARQ-ACK codebook may include two parts (denoted as part #1D and part #2D for clarity). Generating the HARQ-ACK codebook may include: generating part #1D including HARQ-ACK information bits for candidate PDSCH reception occasions of each cell of the first set of cells and generating part #2D including a HARQ-ACK information bit(s) for one or more PDSCHs among the first set of PDSCHs received on one or more cell(s) of the first set of cells and located outside of candidate PDSCH reception occasions of the one or more cell(s) of the first set of cells.

In some embodiments of the present disclosure, part #1D and part #2D may be arranged in the HARQ-ACK codebook according to a predefined order. For example, part #1D is placed firstly in the HARQ-ACK codebook and followed by part #2D. For example, part #2D is placed firstly in the HARQ-ACK codebook and followed by part #1D.

The descriptions with respect to part #1C in Method #3 may apply to part #1D in Method #4, except that for part #1D, when a PDSCH is actually scheduled on a cell within a certain candidate PDSCH reception occasion of the cell, the HARQ-ACK information bit(s) for this candidate PDSCH reception occasion is HARQ-ACK information bit(s) for this PDSCH, that is, ACK or NACK depending on the decoding result of the PDSCH. In other words, the HARQ-ACK information bit(s) for such candidate PDSCH reception occasion may not always indicate NACK.

For example, similarly to part #1C in Method #3, in some embodiments of the present disclosure, the HARQ-ACK information bits in part #1D for candidate PDSCH reception occasions of each cell of the first set of cells may be arranged according to associated candidate PDSCH reception occasions.

For example, similarly to part #1C in Method #3, in some embodiments of the present disclosure, part #1D may include HARQ-ACK information bits for candidate PDSCH reception occasions of a cell in the configured cell set that is not actually scheduled by the first DCI format.

In some embodiments of the present disclosure, the HARQ-ACK information bit(s) in part #2D is arranged according to associated cell indexes. In some embodiments of the present disclosure, the HARQ-ACK information bit(s) in part #2D is arranged firstly according to associated PDSCH starting timing and then according to associated cell indexes.

For example, referring back to FIG. 2, the UE may generate a HARQ-ACK codebook to be transmitted in slot n+9. An example HARQ-ACK codebook 850 according to Method #4 is shown in FIG. 8 and may be transmitted on PUCCH 860.

As shown in FIG. 8, HARQ-ACK codebook 850 includes part 851 and part 852. Part 851 includes HARQ-ACK information bits for candidate PDSCH reception occasions on each of CCs 231-234 (e.g., the cells scheduled by DCI 210 or the configure cell set for multi-cell scheduling). Part 852 includes HARQ-ACK information bits for PDSCHs 221 and 224 among the PDSCHs scheduled by DCI 210 in FIG. 2 received on CCs 231 and 234 and located outside of candidate PDSCH reception occasions of CCs 231 and 234.

For simplicity, it is assumed that the ascending order of cell indexes is employed for arranging HARQ-ACK information bits in part 851 and part 852. For example, denoting the HARQ-ACK information bits for the candidate PDSCH reception occasions of CCs 231-234 in FIG. 2 as d1 to d4, respectively, part 851 may be arranged as {d1, d2, d3, d4}. For example, denoting the HARQ-ACK information bits for PDSCHs 221 and 224 in FIG. 2 respectively as d5 and d6, part 852 in FIG. 8 may be arranged as {d5, d6}.

HARQ-ACK information bits d1 in FIG. 8 include HARQ-ACK information bits for four candidate PDSCH reception occasions of CC 231 in FIG. 2, which may be ordered according to the associated candidate PDSCH reception occasions. Similarly, HARQ-ACK information bits d2, d3, or d4 in FIG. 8 include HARQ-ACK information bits for four candidate PDSCH reception occasions of CC 232, 233, or 234 in FIG. 2, which may be ordered according to the associated candidate PDSCH reception occasions.

For simplicity, it is assumed that for each cell, the ascending order of candidate PDSCH reception occasions is employed.

For example, denoting the HARQ-ACK information bits for the four candidate PDSCH reception occasions of CC 231 in FIG. 2 as d1-1, d1-2, d1-3, and d1-4, HARQ-ACK information bits d1 in FIG. 8 may be denoted as {d1-1, d1-2, d1-3, d1-4}.

In some embodiments, when no PDSCH is actually transmitted in a candidate PDSCH reception occasion of a cell, the HARQ-ACK information bit(s) for this candidate PDSCH reception occasion indicates NACK. For example, d1-1, d1-2, d1-3, and d1-4 may be NACK. That is, HARQ-ACK information bits d1 in FIG. 8 may be denoted as {NACK, NACK, NACK, NACK}. For example, HARQ-ACK information bits d4 in FIG. 8 may be denoted as {NACK, NACK, NACK, NACK}.

In some embodiments, when a PDSCH is actually transmitted in a candidate PDSCH reception occasion of a cell, the HARQ-ACK information bit(s) for this candidate PDSCH reception occasion refers to the HARQ-ACK information bit(s) for this PDSCH.

For example, the HARQ-ACK information bit(s) for the candidate PDSCH reception occasion of CC 232 in slot n+6 in FIG. 2 may refer to the HARQ-ACK information bit(s) for PDSCH 222 since PDSCH 222 is scheduled in slot n+6 on CC 632. For example, denoting the HARQ-ACK information bit(s) for PDSCH 222 as d2-0, HARQ-ACK information bits d2 in FIG. 8 may be denoted as {NACK, d2-0, NACK, NACK}. Similarly, denoting the HARQ-ACK information bit(s) for PDSCH 223 in slot n+5 on CC 633 as d3-0, HARQ-ACK information bits d3 in FIG. 8 may be denoted as {d3-0, NACK, NACK, NACK}.

From the perspective of a UE, the following steps may be performed for generating a Type-1 HARQ-ACK codebook according to Method #4:
(4-1) A UE checks the K0 value for each of co-scheduled PDSCHs as indicated by the TDRA field and finds out the reference PDSCH which ends last among the co-scheduled PDSCHs.
(4-2) The UE determines the slot where the PUCCH carrying HARQ-ACK feedback for the co-scheduled PDSCHs is transmitted.
(4-3) The UE identifies the candidate PDSCH reception occasions for each of the co-scheduled cells (or configured cell set) according to the respective K1 set of each of the co-scheduled cells (or configured cell set) and the slot where the PUCCH is transmitted.
(4-4) The UE generates part #1D comprising HARQ-ACK information bits for each candidate PDSCH reception occasion for each cell of the co-scheduled cells (or configured cell set) and orders the generated HARQ-ACK information bits firstly according to (e.g., in an ascending order of) candidate PDSCH reception occasions for each of the co-scheduled cells (or configured cell set) and then according to (e.g., in an ascending order of) serving cell indexes of the co-scheduled cells (or configured cell set).
(4-5) The UE checks whether there is one or multiple PDSCHs scheduled by a multi-cell scheduling DCI format(s) (e.g., DCI format 1_X, or the first DCI format) and located outside of the candidate PDSCH reception occasions for each cell of the co-scheduled cells.
   If there is only a single PDSCH scheduled by the DCI format and located outside of the candidate PDSCH reception occasions for the associated cell, the UE generates part #2D including HARQ-ACK information bit(s) for the single PDSCH.
   If there are multiple PDSCHs scheduled by the DCI format and located outside of the candidate PDSCH reception occasions on respective cells, the UE generates part #2D including HARQ-ACK information bits for the multiple PDSCHs and orders the HARQ-ACK information bits for the multiple PDSCHs.
   i. In one embodiment, the HARQ-ACK information bits for the multiple PDSCHs are ordered according to (e.g., in an ascending order of) associated serving cell indexes.
   ii. In another embodiment, the HARQ-ACK information bits for the multiple PDSCHs are ordered according to (e.g., in an ascending order of) PDSCH starting timing. If there are two or more PDSCHs among the multiple PDSCHs having the same staring timing, then the HARQ-ACK information bits for the two or more PDSCHs are ordered according to (e.g., in an ascending order of) associated serving cell indexes.
(4-6) The UE concatenates part #1D and part #2D as the Type-1 HARQ-ACK codebook for transmitting on the PUCCH.

From the perspective of a BS, it may transmit, to the UE, a DCI format scheduling a plurality of PDSCHs, and may receive, from the UE, a Type-1 HARQ-ACK codebook as generated above.

### Method #5

In some embodiments of the present disclosure, generating the HARQ-ACK codebook may include for each cell of the first set of cells, generating a part (denoted as part #1E) including HARQ-ACK information bits for candidate PDSCH reception occasions of a corresponding cell. The HARQ-ACK information bits for candidate PDSCH reception occasions in part #1E are ordered according to associated PDSCH reception occasions (e.g., a predefined order, such as an ascending order or descending order of the candidate PDSCH reception occasions on the corresponding cell).

In some embodiments of the present disclosure, in the case that a PDSCH (denoted as PDSCH #1E) of the first set of PDSCHs is received on a cell of the first set of cells and located outside of the candidate PDSCH reception occasions of this cell, generating the HARQ-ACK codebook may further include generating another part (denoted as part #2E) for this cell. Part #2E includes a HARQ-ACK information bit(s) for PDSCH #1E.

The UE may concatenate part #1E and part #2E for this cell to form the HARQ-ACK feedback for this cell. In some embodiments of the present disclosure, part #1E and part #2E may be concatenated according to a predefined order. For example, part #1E is placed in front of part #2E. For example, part #2E is placed in front of part #1E.

In some embodiments of the present disclosure, the HARQ-ACK information bits for each cell of the first set of cells are arranged according to associated serving cell indices (e.g., a predefined order such as an ascending order or descending order of the serving cell indexes of the first set of cells).

In some embodiments, the first set of cells may be a subset of a cell set configured for multi-cell scheduling. Generating the HARQ-ACK codebook may further include for a cell(s) in the configured cell set that can be scheduled but not actually scheduled by the first DCI format, generating part(s) #1E for such cell(s). The HARQ-ACK information bits for each cell of the configured cell set are arranged according to associated serving cell indices (e.g., a predefined order such as an ascending order or descending order of the serving cell indexes of the configured cell set).

For example, referring back to FIG. 2, the UE may generate a HARQ-ACK codebook to be transmitted in slot n+9. An example HARQ-ACK codebook 950 according to Method #5 is shown in FIG. 9. In the example of FIG. 9, it is assumed that part #1E is placed in front of part #2E and an ascending order of the serving cell indexes is employed for arranging HARQ-ACK information bits for each cell.

As shown in FIG. 9, HARQ-ACK codebook 950 may include HARQ-ACK information bits e1 and a HARQ-ACK information bit(s) f1 for CC 231 in FIG. 2, HARQ-ACK information bits e2 for CC 232 in FIG. 2, HARQ-ACK information bits e3 for CC 233 in FIG. 2, and HARQ-ACK information bits e4 and a HARQ-ACK information bit(s) f4 for CC 234 in FIG. 2. HARQ-ACK information bits e1 to e4 respectively denote HARQ-ACK information bits for candidate PDSCH reception occasions of CCs 231 to 234 in FIG. 2. The HARQ-ACK information bits f1 and f4 respectively denote HARQ-ACK information bits for PDSCHs 221 and 224 in FIG. 2.

In some embodiments, when a PDSCH is actually transmitted in a candidate PDSCH reception occasion of a cell, the HARQ-ACK information bit(s) for this candidate PDSCH reception occasion refers to the HARQ-ACK information bit(s) for this PDSCH. In some embodiments, when no PDSCH is actually transmitted in a candidate PDSCH reception occasion of a cell, the HARQ-ACK information bit(s) for this candidate PDSCH reception occasion indicates NACK.

For example, denoting the HARQ-ACK information bits for PDSCHs 222 and 223 respectively as f2 and f3, HARQ-ACK information bits e1 to e4 may be denoted as {NACK, NACK, NACK, NACK}, {NACK, f2, NACK, NACK}, {f3, NACK, NACK, NACK}, and {NACK, NACK, NACK, NACK}, respectively.

From the perspective of a UE, the following steps may be performed for generating a Type-1 HARQ-ACK codebook according to Method #5:
(5-1) A UE checks the K0 value for each of co-scheduled PDSCHs as indicated by the TDRA field and finds out the reference PDSCH which ends last among the co-scheduled PDSCHs.
(5-2) The UE determines the slot where the PUCCH carrying HARQ-ACK feedback for the co-scheduled PDSCHs is transmitted.
(5-3) The UE identifies the candidate PDSCH reception occasions for each of the co-scheduled cells (or configured cell set) according to the respective K1 set of each of the co-scheduled cells (or configured cell set) and the slot where the PUCCH is transmitted.
(5-4) For each cell of the co-scheduled cells (or configured cell set),
   the UE generates part #1E including HARQ-ACK information bits for each candidate PDSCH reception occasion on the cell;
   the UE checks whether there is one or multiple PDSCHs which are scheduled by a multi-cell scheduling DCI format(s) (e.g., DCI format 1_X or the first DCI format) and located outside of the candidate PDSCH reception occasions on the cell;
   if only a single PDSCH scheduled by a multi-cell scheduling DCI format is outside of the candidate PDSCH reception occasions on the cell, the UE generates part #2E including HARQ-ACK information bit(s) for the single PDSCH; and
   if there are multiple PDSCHs scheduled by multiple multi-cell scheduling DCI formats outside of the candidate PDSCH reception occasions on the cell, the UE generates part #2E including HARQ-ACK information bit(s) for the multiple PDSCHs.
(5-5) The UE concatenates HARQ-ACK information bits for each cell of the co-scheduled cells (or configured cell set) as the Type-1 HARQ-ACK codebook for transmitting on the PUCCH.

From the perspective of a BS, it may transmit, to the UE, a DCI format scheduling a plurality of PDSCHs, and may receive, from the UE, a Type-1 HARQ-ACK codebook as generated above.

As stated above, in some embodiments, all DCI formats 1_X are configured or predefined with the same set of cells for multi-cell scheduling; and in some other embodiments, a plurality of sets of cells may be configured or predefined for multi-cell scheduling. Methods (e.g., Methods #1 to #5) described above with respect to solution #1 are applicable to both cases.

For example, referring to FIG. 3, the UE may receive a second DCI format scheduling a second set of PDSCHs on a second set of cells of the UE, wherein HARQ-ACK feedback for the second set of PDSCHs is to be multiplexed in the HARQ-ACK codebook. In some embodiments of the present disclosure, each of the first and second sets of cells is a subset of a respective set of cells configured for multi-cell scheduling, or is a subset of the same set of cells configured for multi-cell scheduling.

In some embodiments of the present disclosure, Method #1 is employed. For example, generating the HARQ-ACK codebook may include generating HARQ-ACK feedback for each cell of the first and second sets of cells, which may include: generating HARQ-ACK information bits for candidate PDSCH reception occasions of a corresponding cell of the first and second sets of cells; and generating a HARQ-ACK information bit(s) for a PDSCH (denoted as PDSCH #1A′) received on the corresponding cell and located outside of the candidate PDSCH reception occasions of the corresponding cell.

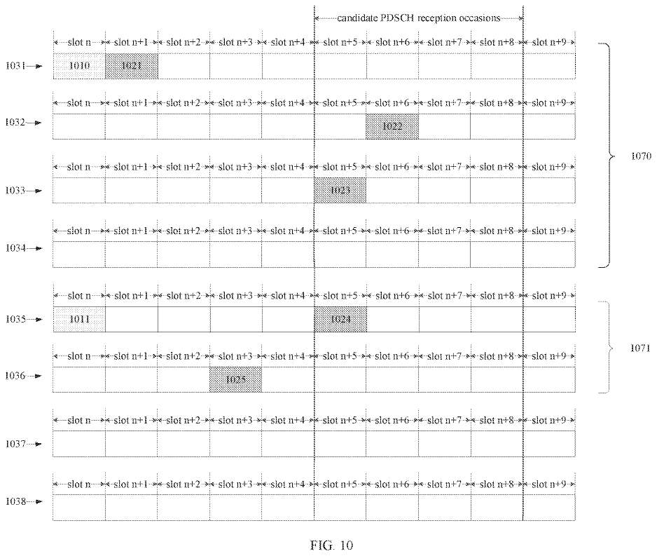

For example, referring to FIG. 10, a UE may be configured with a plurality of cells (e.g., CCs 1031-1038), and a plurality sets of cells (e.g., cell set 1070 and cell set 1071) for multi-cell scheduling. Cell set 1070 may include CCs 1031-1034 and Cell set 1071 may include CCs 1035 and 1036. CCs 1037 and 1038 may not be used for multi-cell scheduling. For simplicity, it is assumed that the serving cell indices of CCs 1031-1038 are: CC 1031<CC 1032<CC 1033<CC 1034<CC 1035<CC 1036<CC 1037<CC 1038.

DCI 1010 transmitted in slot n on CC 1031 may schedule PDSCH 1021 in slot n+1 on CC 1031, PDSCH 1022 in slot n+6 on CC 1032, and PDSCH 1023 in slot n+5 on CC 1033. That is, DCI 1010 does not schedule CC 1034 in cell set 1070. DCI 1011 transmitted in slot n on CC 1035 may schedule PDSCH 1024 in slot n+5 on CC 1035, and PDSCH 1025 in slot n+3 on CC 1036. The UE may determine that HARQ-ACK information bits for PDSCHs 1021-1025 are to be multiplexed in the same PUCCH in slot n+9, and candidate PDSCH reception occasions for each cell of CCs 1031-1038 are in slots n+5 to n+8. The HARQ-ACK information bits for PDSCHs 1021-1025 are denoted as h1 to h5, respectively.

When Method #1 is employed, in some embodiments, the UE may generate a HARQ-ACK codebook of {{h1, NACK, NACK, NACK, NACK}, {NACK, h2, NACK, NACK}, {h3, NACK, NACK, NACK}, {NACK, NACK, NACK, NACK}, {h4, NACK, NACK, NACK}, {h5, NACK, NACK, NACK, NACK} {NACK, NACK, NACK, NACK}, {NACK, NACK, NACK, NACK}}.

In some embodiments of the present disclosure, Method #2 is employed. For example, generating the HARQ-ACK codebook may include generating HARQ-ACK feedback for each cell of the first and second sets of cells, which may include: generating HARQ-ACK information bits for candidate PDSCH reception occasions of a corresponding cell of the first and second sets of cells; and generating a HARQ-ACK information bit(s) for a PDSCH (denoted as PDSCH #1B′) which can be potentially scheduled on the corresponding cell by the first DCI format or the second DCI format.

For example, still referring to FIG. 10, it is assumed that Method #2 is employed. In some embodiments, the UE may generate a HARQ-ACK codebook of {{h1, NACK, NACK, NACK, NACK}, {h2, NACK, NACK, NACK, NACK}, {h3, NACK, NACK, NACK, NACK}, {NACK, NACK, NACK, NACK, NACK}, {h4, NACK, NACK, NACK, NACK}, {h5, NACK, NACK, NACK, NACK}, {NACK, NACK, NACK, NACK}, {NACK, NACK, NACK, NACK}}. In some embodiments, the UE may generate a HARQ-ACK codebook of {{h1, NACK, NACK, NACK, NACK}, {h2, NACK, h2, NACK, NACK}, {h3, h3, NACK, NACK, NACK}, {NACK, NACK, NACK, NACK, NACK}, {h4, h4, NACK, NACK, NACK}, {h5, NACK, NACK, NACK, NACK}, {NACK, NACK, NACK, NACK}, {NACK, NACK, NACK, NACK}}.

In some embodiments of the present disclosure, Method #3 is employed. For example, the HARQ-ACK codebook may include part #1C′ and part #2C′. Generating the HARQ-ACK codebook may include: generating part #1C′ including HARQ-ACK information bits for candidate PDSCH reception occasions of each cell of the first and second sets of cells and generating part #2C′ including HARQ-ACK information bits for all cells which can be potentially scheduled by the first DCI format and the second DCI format with one PDSCH on each cell.

In some embodiments of the present disclosure, the HARQ-ACK information bits in part #2C′ are arranged according to cell indexes of the first and second sets of cells. In some embodiments of the present disclosure, the HARQ-ACK information bits in part #2C′ are arranged firstly according to associated cell set indexes and then according to associated serving cell indexes within a corresponding set of the first and second sets of cells.

In the case that a plurality of cell sets is configured or predefined for multi-cell scheduling, in some embodiments of the present disclosure, if at least one cell of the plurality of cell sets is configured with a maximum of 2 codewords per PDSCH without spatial bundling, the number of HARQ-ACK information bits in part #2C′ may be based on (e.g., equal to) M′*Z, where M′ is the maximum number of TBs which can be co-scheduled by a DCI format 1_X in a PUCCH group for the UE and Z is the number of cell sets configured for the UE in the same PUCCH group.

In some other embodiments of the present disclosure, if at least one cell of the plurality of cell sets is configured with a maximum of 2 codewords per PDSCH without spatial bundling, the number of HARQ-ACK information bits in part #2C′ may be based on (e.g., equal to) M₁+M₂+ . . . +M_{Z}, where M₁, M₂, . . . , M_{Z} are the respective maximum number of TBs of each cell in the plurality of cell sets in the same PUCCH group for the UE and Z is the number of cell sets configured for the UE in the same PUCCH group. For example, M′=max (M₁, M₂, . . . , M_{Z}).

In some embodiments of the present disclosure, if none cell in the plurality of cell sets is configured with a maximum of 2 codewords per PDSCH, or if one or more cells in the plurality of cell sets are configured with a maximum of 2 codewords per PDSCH and configured with spatial bundling, the number of HARQ-ACK information bits in part #2C′ may be based on (e.g., equal to) N′*Z, where N′ is the maximum number of cells which can be co-scheduled by a DCI format 1_X in the PUCCH group for the UE (e.g., the total number of cells in the plurality of cell sets) and Z is the number of cell sets configured for the UE in the same PUCCH group.

In some other embodiments of the present disclosure, if none cell in the plurality of cell sets is configured with a maximum of 2 codewords per PDSCH, or if one or more cells in the plurality of cell sets are configured with a maximum of 2 codewords per PDSCH and configured with spatial bundling, the number of HARQ-ACK information bits in part #2C′ may be based on (e.g., equal to) N₁+N₂+ . . . +N_{Z}, where N₁, N₂, . . . , N_{Z} are the respective number of cells in the plurality of cell sets in the same PUCCH group for the UE and Z is the number of cell sets configured for the UE in the same PUCCH group. For example, N′=max (N₁, N₂, . . . , N_{Z}).

For example, still referring to FIG. 10, it is assumed that Method #3 is employed. In some embodiments, the UE may generate HARQ-ACK codebook 1150 as shown in FIG. 11 for transmitting on PUCCH 1160. HARQ-ACK codebook 1150 may include two parts, i.e., part 1151 (e.g., part #1C′) may be denoted as {g1, g2, g3, g4, g5, g6, g7, g8} and part 1152 (e.g., part #2C′) may be denoted as {h1, h2, h3, NACK, h4, h5}, wherein g1, g2, g3, g4, g5, g6, g7 and g8 respectively denote HARQ-ACK information bits for candidate PDSCH reception occasions of cells in the configured cell sets (e.g., cell sets 1070 and 1071) corresponding to DCI 1010 and DCI 1011 and HARQ-ACK information bits for candidate PDSCH reception occasions of cells 1037 and 1038.

In some embodiments of the present disclosure, Method #4 is employed. For example, the HARQ-ACK codebook may include part #1D′ including HARQ-ACK information bits for candidate PDSCH reception occasions of each cell of the first and second sets of cells, and part #2D′ including a HARQ-ACK information bit(s) for one or more PDSCHs among the first set and second sets of PDSCHs received on one or more cell(s) of the first and second sets of cells and located outside of candidate PDSCH reception occasions of the one or more cell(s) of the first second sets of cells.

For example, still referring to FIG. 10, it is assumed that Method #4 is employed. In some embodiments, the UE may generate a HARQ-ACK codebook of {{i1, i2, i3, i4, i5, i6, i7, i8}, {h1, h5}}, wherein i1, i2, i3, i4, i5, i6, i7 and i8 respectively denote HARQ-ACK information bits for candidate PDSCH reception occasions of cells in the configured cell sets (e.g., cell sets 1070 and 1071) corresponding to DCI 1010 and DCI 1011 and HARQ-ACK information bits for candidate PDSCH reception occasions of cells 1037 and 1038.

In some embodiments of the present disclosure, Method #5 is employed. For example, generating the HARQ-ACK codebook may include generating HARQ-ACK feedback for each cell of the first and second sets of cells, which comprises: part #1E′ including HARQ-ACK information bits for candidate PDSCH reception occasions of a corresponding cell of the first and second sets of cells; and part #2E′ including a HARQ-ACK information bit(s) for a PDSCH (denoted as PDSCH #1E′) of the first and second sets of PDSCHs in response to PDSCH #1E′ being received on the corresponding cell and located outside of the candidate PDSCH reception occasions of the corresponding cell.

For example, still referring to FIG. 10, it is assumed that Method #5 is employed. In some embodiments, the UE may generate a HARQ-ACK codebook of {{h1, j1}, j2, j3, j4, j5, {h5, j6}}, j7, j8}, wherein j1, j2, j3, j4, j5, j6, j7 and j8 respectively denote HARQ-ACK information bits for candidate PDSCH reception occasions of cells in the configured cell sets (e.g., cell sets 1070 and 1071) corresponding to DCI 1010 and DCI 1011 and HARQ-ACK information bits for candidate PDSCH reception occasions of cells 1037 and 1038.

In some embodiments of the present disclosure, both the BS and the UE should synchronize the same reference PDSCH for the UE to determine the slot where the HARQ-ACK feedback for the co-scheduled PDSCHs is transmitted, the same candidate PDSCH reception occasions on each cell of the co-scheduled cells or the configured cell set, and the same understanding on HARQ-ACK information bits for candidate PDSCH reception occasions on all cells of the co-scheduled cells or the configured cell set.

In some embodiments of the present disclosure, solutions for avoiding the scenario where a PDSCH scheduled by a DCI format is located outside of the candidate PDSCH reception occasions are provided (hereinafter, solution #2). As will be described in the following text, various methods can be employed to achieve solution #2.

### Method #6

In some embodiments of the present disclosure, for a UE, when Type-1 HARQ-ACK codebook is configured and a set of cells is configured for multi-cell scheduling using DCI format 1_X, when the DCI format 1_X is received for co-scheduling multiple cells of the set of cells, the TDRA field in the DCI format 1_X should indicate the same K0 value for each of co-scheduled PDSCHs, i.e., the co-scheduled PDSCHs should be scheduled in the same slot. The UE does not expect to be indicated with different K0 values for each of co-scheduled PDSCHs. In other words, the BS should make sure that the TDRA field in a DCI format 1_X should indicate the same K0 value for each of co-scheduled PDSCHs.

For example, the first DCI format received in operation 311 of FIG. 3 may include an indicator indicating the same slot level offset for each of the first set of PDSCHs with reference to the slot where the first DCI format is received, and the HARQ-ACK feedback for the first set of PDSCHs may be included in the HARQ-ACK feedback associated with the candidate PDSCH reception occasions on the first set of cells.

### Method #7

For a UE, when Type-1 HARQ-ACK codebook is configured and a set of cells is configured for multi-cell scheduling using DCI format 1_X, when the DCI format 1_X is received for co-scheduling multiple cells of the set of cells, the co-scheduled PDSCHs should be included in candidate PDSCH reception occasions on associated cells.

In some embodiments of the present disclosure, the K0 value configuration for each co-scheduled cell in the TDRA table and K1 set for each co-scheduled cell as well as the k1 value indicated by PDSCH-to-HARQ_feedback timing indicator in the DCI format 1_X may be set in a certain way to achieve this purpose, for example, they may satisfy below condition:
for cell X of co-scheduled cells, n−(Δₘₐₓ−K_{0,Z})>=n+k−B_{max, X}, i.e., k<=Bₘₐₓ, x−(Δₘₐₓ−K_{0,Z}),
   wherein Δₘₐₓ is the maximum K0 value for the co-scheduled cells, B_{max,X} is the maximum k1 value among the K1 set for cell X, K_{0,Z} is the K0 value for cell X, k is the k1 value indicated by PDSCH-to-HARQ_feedback timing indicator in the DCI format 1_X, and n is the slot where the reference PDSCH is transmitted, and the reference PDSCH is the PDSCH with the largest K0 value among the co-scheduled PDSCHs.

At a UE side, for cell X of co-scheduled cells, UE does not expect to be indicated a k1 value in the DCI format 1_X which does not satisfy the condition of k<=B_{max, X}−(Δₘₐₓ−K_{0,Z}).

For example, as shown in Table 1 below, assuming that K1 set is {1, 2, 3, 4} for each cell of the cells co-scheduled by a DCI format 1_X, the maximum k1 value is 4.

In some examples, when row index 0 is indicated by a TDRA field in the DCI format 1_X, the max K0 value is 6. If the indicated k1 value is 3, to meet 3<=4−(6−K_{0,Z}), K_{0,Z} should be >=5. So PDSCHs on Cell 1 and Cell 4 would be outside of candidate PDSCH reception occasions on Cell 1 and Cell 4.

In some examples, when row index 1 is indicated by a TDRA field in the DCI format 1_X, the max K0 value is 5. If the indicated k1 value is 3, to meet 3<=4−(5−K_{0,Z}), K_{0,Z} should be >=4. So PDSCHs on Cell 2, Cell 3 and Cell 4 would be outside of candidate PDSCH reception occasions on Cell 2, Cell 3 and Cell 4.

TABLE 1
an example TDRA table configured for multi-cell scheduling
(only K0 is given for illustrative purpose)

| Row index | Cell 1 | Cell 2 | Cell 3 | Cell 4 |
|---|---|---|---|---|
| 0 | K0 = 1 | K0 = 6 | K0 = 5 | K0 = 2 |
| 1 | K0 = 5 | K0 = 3 | K0 = 0 | K0 = 1 |

As can be seen K0 value configuration in TDRA table, K1 set configuration and k1 value should be properly set to meet the condition of k<=B_{max, X}−(Δₘₐₓ−K_{0,Z}). One example which satisfies the condition is shown in Table 2.

TABLE 2
an example TDRA table configured for multi-cell scheduling
(Only K0 is given for illustrative purpose)

| Row index | Cell 1 | Cell 2 | Cell 3 | Cell 4 |
|---|---|---|---|---|
| 0 | K0 = 5 | K0 = 6 | K0 = 5 | K0 = 5 |
| 1 | K0 = 5 | K0 = 4 | K0 = 4 | K0 = 4 |

It should be noted that above condition and tables are only for illustrative purpose. The gist of this method is that when a DCI format 1_X is transmitted for co-scheduling multiple PDSCHs on multiple cells, it should make sure that the co-scheduled PDSCHs are included in the candidate PDSCH reception occasions on associated cells. For example, the first DCI format received in operation 311 of FIG. 3 may include a first indicator indicating separate slot level offset for each of the first set of PDSCHs with reference to the slot where the first DCI format is received, and a second indicator indicating the slot where the HARQ-ACK codebook is transmitted with the restriction that the first set of PDSCHs is included in the candidate PDSCH reception occasions on associated cells of the first set of cells, and the HARQ-ACK feedback for the first set of PDSCHs is included in the HARQ-ACK feedback associated with candidate PDSCH reception occasions on the first set of cells.

It should be appreciated by persons skilled in the art that the sequence of the operations in exemplary procedure 300 may be changed and some of the operations in exemplary procedure 300 may be eliminated or modified, without departing from the spirit and scope of the disclosure.

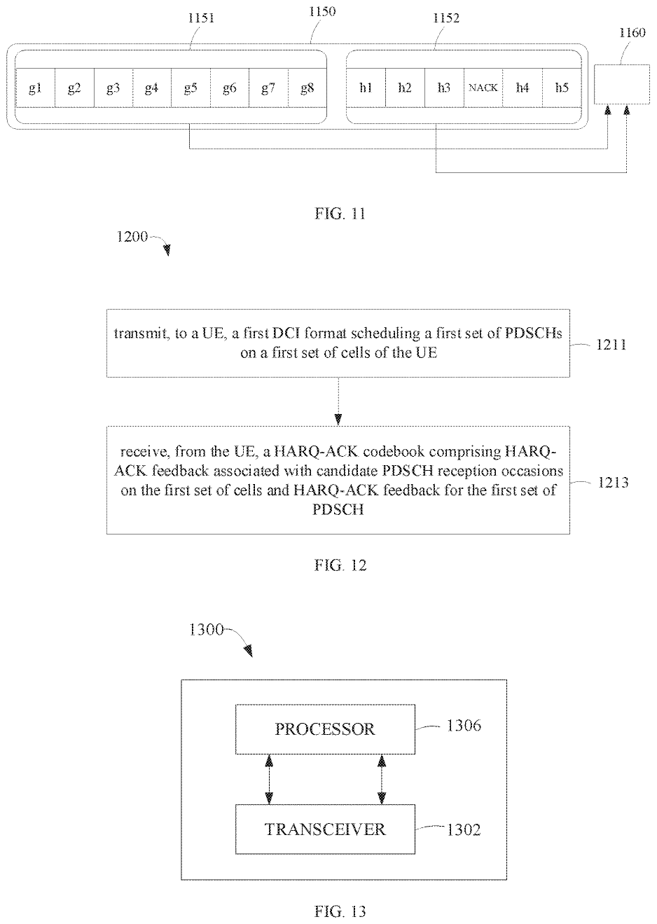

FIG. 12 illustrates a flow chart of an exemplary procedure 1200 for wireless communications in accordance with some embodiments of the present disclosure. Details described in all of the foregoing embodiments of the present disclosure are applicable for the embodiments shown in FIG. 12. In some examples, the procedure may be performed by a BS, for example, BS 102 in FIG. 1.

Referring to FIG. 12, in operation 1211, a BS may transmit, to a UE, a first DCI format scheduling a first set of PDSCHs on a first set of cells of the UE. The descriptions with respect to the first DCI format and DCI format 1_X in the forgoing may be applied to the first DCI format in operation 1211.

In operation 1213, the BS may receive, from the UE, a HARQ-ACK codebook including HARQ-ACK feedback associated with candidate PDSCH reception occasions on the first set of cells and HARQ-ACK feedback for the first set of PDSCH. The HARQ-ACK codebook may be generated by the UE according to one of Methods #1 to #7 as described above.

For example, in some embodiments of the present disclosure, according to Method #1, the HARQ-ACK codebook may include HARQ-ACK information bits for each cell of the first set of cells which are ordered according to associated serving cell index. In some embodiments, the HARQ-ACK information bits for each cell of the first set of cells may include HARQ-ACK information bits for candidate PDSCH reception occasions of a corresponding cell; and a HARQ-ACK information bit(s) for a first PDSCH of the first set of PDSCHs transmitted on the corresponding cell and located outside of the candidate PDSCH reception occasions of the corresponding cell. In some embodiments, the HARQ-ACK information bits for the candidate PDSCH reception occasions of the corresponding cell and the HARQ-ACK information bit(s) for the first PDSCH are ordered according to PDSCH reception occasions on the corresponding cell.

For example, in some embodiments of the present disclosure, according to Method #2, the HARQ-ACK codebook may include HARQ-ACK information bits for each cell of the first set of cells which are ordered according to associated serving cell index. In some embodiments, the HARQ-ACK information bits for each cell of the first set of cells may include: HARQ-ACK information bits for candidate PDSCH reception occasions of the corresponding cell; a HARQ-ACK information bit(s) for a first PDSCH which can be potentially scheduled on the corresponding cell by the first DCI format.

In some embodiments, the HARQ-ACK information bit(s) for the first PDSCH is placed after or before the HARQ-ACK information bits for the candidate PDSCH reception occasions of the corresponding cell. In some embodiments, the HARQ-ACK information bits for the candidate PDSCH reception occasions of the corresponding cell are arranged according to PDSCH reception occasions on the corresponding cell.

In some embodiments, in the case that the first PDSCH is actually scheduled on the corresponding cell by the first DCI format, the HARQ-ACK information bit(s) for the first PDSCH is ACK or NACK dependent on the decoding result of the first PDSCH. In some embodiments, in the case that the first PDSCH is not scheduled on the corresponding cell by the first DCI format, the HARQ-ACK information bit(s) for the first PDSCH is NACK.

For example, in some embodiments of the present disclosure, according to Method #3, the HARQ-ACK codebook may include a first part and a second part, the first part may include HARQ-ACK information bits for candidate PDSCH reception occasions of each cell of the first set of cells, and the second part may include HARQ-ACK information bits for all cells which can be potentially scheduled by the first DCI format with one PDSCH on each cell.

In some embodiments, in the case that a cell which can be potentially scheduled by the first DCI format is not included in the first set of cells, a HARQ-ACK information bit(s) in the second part for the cell is NACK. In some embodiments, HARQ-ACK information bit(s) in the second part for a cell of the first set of cells scheduled by the first DCI format is ACK or NACK.

In some embodiments, in the case that a second PDSCH of the first set of PDSCHs is scheduled on a cell of the first set of cells and included within candidate PDSCH reception occasions of the cell, the HARQ-ACK information bit(s) for the second PDSCH in the first part for the cell is ACK or NACK depending on a decoding result of the second PDSCH, or NACK.

In some embodiments, the HARQ-ACK information bits in the first part for candidate PDSCH reception occasions of each cell of the first set of cells are arranged according to associated candidate PDSCH reception occasions. In some embodiments, the HARQ-ACK information bit(s) in the second part is arranged according to associated cell indexes.

For example, in some embodiments of the present disclosure, according to Method #4, the HARQ-ACK codebook may include a first part and a second part, the first part may include HARQ-ACK information bits for candidate PDSCH reception occasions of each cell of the first set of cells, and the second part may include a HARQ-ACK information bit(s) for one or more PDSCHs among the first set of PDSCHs transmitted on one or more cell(s) of the first set of cells and located out of candidate PDSCH reception occasions of the one or more cell(s) of the first set of cells.

In some embodiments, the HARQ-ACK information bits in the first part for candidate PDSCH reception occasions of each cell of the first set of cells are arranged according to associated candidate PDSCH reception occasions. In some embodiments, the HARQ-ACK information bit(s) in the second part is arranged according to associated cell indexes. In some embodiments, the HARQ-ACK information bit(s) in the second part is arranged firstly according to associated PDSCH starting timing and then according to associated cell indexes.

For example, in some embodiments of the present disclosure, according to Method #5, the HARQ-ACK codebook may include: for each cell of the first set of cells, a first part comprising HARQ-ACK information bits for candidate PDSCH reception occasions of the corresponding cell; and a second part comprising a HARQ-ACK information bit(s) for a first PDSCH of the first set of PDSCHs in response to the first PDSCH being transmitted on the corresponding cell and located outside of the candidate PDSCH reception occasions of the corresponding cell.

In some embodiments, the HARQ-ACK information bits for each cell of the first set of cells are arranged according to associated serving cell indices.

In some embodiments of the present disclosure, the BS may further transmit, to the UE, a second DCI format scheduling a second set of PDSCHs on a second set of cells of the UE, wherein HARQ-ACK feedback for the second set of PDSCHs is to be multiplexed in the HARQ-ACK codebook.

In some embodiments of the present disclosure, each of the first and second sets of cells is a subset of a respective set of cells configured for multi-cell scheduling. In some embodiments of the present disclosure, each of the first and second sets of cells is a subset of the same set of cells configured for multi-cell scheduling.

In some embodiments of the present disclosure, the HARQ-ACK codebook may include HARQ-ACK feedback for each cell of the first and second sets of cells, which may include: HARQ-ACK information bits for candidate PDSCH reception occasions of a corresponding cell of the first and second sets of cells; and a HARQ-ACK information bit(s) for a first PDSCH transmitted on the corresponding cell and located outside of the candidate PDSCH reception occasions of the corresponding cell.

In some embodiments of the present disclosure, the HARQ-ACK codebook may include HARQ-ACK feedback for each cell of the first and second sets of cells, which may include: HARQ-ACK information bits for candidate PDSCH reception occasions of a corresponding cell of the first and second sets of cells; and a HARQ-ACK information bit(s) for a first PDSCH which can be potentially scheduled on the corresponding cell by the first DCI format or the second DCI format.

In some embodiments of the present disclosure, the HARQ-ACK codebook may include a first part and a second part, the first part may include HARQ-ACK information bits for candidate PDSCH reception occasions of each cell of the first and second sets of cells, and the second part may include HARQ-ACK information bits for all cells which can be potentially scheduled by the first DCI format and the second DCI format with one PDSCH on each cell.

In some embodiments, the HARQ-ACK information bits in the second part are arranged according to cell indexes of the first and second sets of cells. In some embodiments, the HARQ-ACK information bits in the second part are arranged firstly according to associated cell set indexes and then according to associated serving cell indexes within a corresponding set of the first and second sets of cells.

In some embodiments of the present disclosure, the HARQ-ACK codebook may include a first part comprising HARQ-ACK information bits for candidate PDSCH reception occasions of each cell of the first and second sets of cells, and a second part comprising HARQ-ACK information bit(s) for one or more PDSCHs among the first set and second sets of PDSCHs transmitted on one or more cell(s) of the first and second sets of cells and located out of candidate PDSCH reception occasions of the one or more cell(s) of the first second sets of cells.

In some embodiments of the present disclosure, the HARQ-ACK codebook may include HARQ-ACK feedback for each cell of the first and second sets of cells, which may include: a first part comprising HARQ-ACK information bits for candidate PDSCH reception occasions of a corresponding cell of the first and second sets of cells; and a second part comprising a HARQ-ACK information bit(s) for a first PDSCH of the first and second sets of PDSCHs in response to the first PDSCH being transmitted on the corresponding cell and located outside of the candidate PDSCH reception occasions of the corresponding cell.

In some embodiments of the present disclosure, the first DCI format may include an indicator indicating the same slot level offset for each of the first set of PDSCHs with reference to the slot where the first DCI format is transmitted, and the HARQ-ACK feedback for the first set of PDSCHs is included in the HARQ-ACK feedback associated with the candidate PDSCH reception occasions on the first set of cells.

In some embodiments of the present disclosure, the first DCI format may include a first indicator indicating separate slot level offset for each of the first set of PDSCHs with reference to the slot where the first DCI format is transmitted and a second indicator indicating the slot where the HARQ-ACK codebook is transmitted with the restriction that the first set of PDSCHs is included in the candidate PDSCH reception occasions on associated cells of the first set of cells, and the HARQ-ACK feedback for the first set of PDSCHs is included in the HARQ-ACK feedback associated with candidate PDSCH reception occasions on the first set of cells.

It should be appreciated by persons skilled in the art that the sequence of the operations in exemplary procedure 1200 may be changed and some of the operations in exemplary procedure 1200 may be eliminated or modified, without departing from the spirit and scope of the disclosure.

FIG. 13 illustrates a block diagram of an exemplary apparatus 1300 according to some embodiments of the present disclosure. As shown in FIG. 13, the apparatus 1300 may include at least one processor 1306 and at least one transceiver 1302 coupled to the processor 1306. The apparatus 1300 may be a UE or a BS.

Although in this figure, elements such as the at least one transceiver 1302 and processor 1306 are described in the singular, the plural is contemplated unless a limitation to the singular is explicitly stated. In some embodiments of the present application, the transceiver 1302 may be divided into two devices, such as a receiving circuitry and a transmitting circuitry. In some embodiments of the present application, the apparatus 1300 may further include an input device, a memory, and/or other components.

In some embodiments of the present application, the apparatus 1300 may be a UE. The transceiver 1302 and the processor 1306 may interact with each other so as to perform the operations with respect to the UE described in FIGS. 1-12. In some embodiments of the present application, the apparatus 1300 may be a BS. The transceiver 1302 and the processor 1306 may interact with each other so as to perform the operations with respect to the BS described in FIGS. 1-12.

In some embodiments of the present application, the apparatus 1300 may further include at least one non-transitory computer-readable medium.

For example, in some embodiments of the present disclosure, the non-transitory computer-readable medium may have stored thereon computer-executable instructions to cause the processor 1306 to implement the method with respect to the UE as described above. For example, the computer-executable instructions, when executed, cause the processor 1306 interacting with transceiver 1302 to perform the operations with respect to the UE described in FIGS. 1-12.

In some embodiments of the present disclosure, the non-transitory computer-readable medium may have stored thereon computer-executable instructions to cause the processor 1306 to implement the method with respect to the BS as described above. For example, the computer-executable instructions, when executed, cause the processor 1306 interacting with transceiver 1302 to perform the operations with respect to the BS described in FIGS. 1-12.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
receive a first downlink control information (DCI) format scheduling a first set of physical downlink shared channels (PDSCHs) on a first set of cells;
generate a hybrid automatic repeat request acknowledgement (HARQ-ACK) codebook comprising HARQ-ACK feedback associated with candidate PDSCH reception occasions on the first set of cells and HARQ-ACK feedback for the first set of PDSCHs; and
transmit the HARQ-ACK codebook.

2. The UE of claim 1, wherein to generate the HARQ-ACK codebook, the at least one processor is further configured to cause the UE to generate HARQ-ACK information bits for each cell of the first set of cells and concatenate the generated HARQ-ACK information bits for each cell of the first set of cells in order of associated serving cell index.

3. The UE of claim 2, wherein to generate the HARQ-ACK information bits for each cell of the first set of cells, the at least one processor is further configured to cause the UE to:
generate HARQ-ACK information bits for candidate PDSCH reception occasions of a corresponding cell; and
generate at least one HARQ-ACK information bit for a first PDSCH of the first set of PDSCHs received on the corresponding cell and located outside of the candidate PDSCH reception occasions of the corresponding cell.

4. The UE of claim 2, wherein to generate the HARQ-ACK information bits for each cell of the first set of cells, the at least one processor is further configured to cause the UE to: comprises:
generate HARQ-ACK information bits for candidate PDSCH reception occasions of a corresponding cell; and
generate at least one HARQ-ACK information bit for a first PDSCH which can be potentially scheduled on the corresponding cell by the first DCI format.

5. The UE of claim 1, wherein the HARQ-ACK codebook comprises a first part and a second part, and generating wherein to generate the HARQ-ACK codebook, the at least one processor is further configured to cause the UE to generate the first part comprising HARQ-ACK information bits for candidate PDSCH reception occasions of each cell of the first set of cells and generate the second part comprising HARQ-ACK information bits for all cells which can be potentially scheduled by the first DCI format with one PDSCH on each cell.

6. The UE of claim 1, wherein the HARQ-ACK codebook comprises a first part and a second part, and generating wherein to generate the HARQ-ACK codebook, the at least one processor is further configured to cause the UE to generate the first part comprising HARQ-ACK information bits for candidate PDSCH reception occasions of each cell of the first set of cells and generating the second part comprising at least one HARQ-ACK information bit for one or more PDSCHs among the first set of PDSCHs received on one or more cells of the first set of cells and located out of candidate PDSCH reception occasions of the one or more cells of the first set of cells.

7. The UE of claim 1, wherein to generate the HARQ-ACK codebook, the at least one processor is further configured to cause the UE to, for each cell of the first set of cells:
generate a first part comprising HARQ-ACK information bits for candidate PDSCH reception occasions of a corresponding cell;
in a case that a first PDSCH of the first set of PDSCHs is received on the corresponding cell and located outside of the candidate PDSCH reception occasions of the corresponding cell, generate a second part comprising at least one HARQ-ACK information bit for the first PDSCH; and
concatenate the first part and the second part to generate HARQ-ACK feedback for the corresponding cell.

8. The UE of claim 1, wherein the at least one processor is further configured to cause the UE to receive a second DCI format scheduling a second set of PDSCHs on a second set of cells of the UE, wherein HARQ-ACK feedback for the second set of PDSCHs is to be multiplexed in the HARQ-ACK codebook.

9. The UE of claim 8, wherein to generate the HARQ-ACK codebook, the at least one processor is further configured to cause the UE to, comprises generating HARQ-ACK feedback for each cell of the first set of cells and the second set of cells:
generate HARQ-ACK information bits for candidate PDSCH reception occasions of a corresponding cell of the first set of cells and the second set of cells; and
generate at lest one HARQ-ACK information bit for a first PDSCH received on the corresponding cell and located outside of the candidate PDSCH reception occasions of the corresponding cell.

10. The UE of claim 8, wherein to generate the HARQ-ACK codebook, the at least one processor is further configured to cause the UE to, to generate HARQ-ACK feedback for each cell of the first set of cells and the second set of cells:
generate HARQ-ACK information bits for candidate PDSCH reception occasions of a corresponding cell of the first set of cells and the second set of cells; and
generate at least one HARQ-ACK information bit for a first PDSCH which can be potentially scheduled on the corresponding cell by the first DCI format or the second DCI format.

11. The UE of claim 8, wherein the HARQ-ACK codebook comprises a first part and a second part; and to generate the HARQ-ACK codebook, the at least one processor is further configured to cause the UE to generate the first part comprising HARQ-ACK information bits for candidate PDSCH reception occasions of each cell of the first set of cells and the second set of cells and generate the second part comprising HARQ-ACK information bits for all cells which can be potentially scheduled by the first DCI format and the second DCI format with one PDSCH on each cell.

12. The UE of claim 8, wherein the HARQ-ACK codebook comprises a first part comprising HARQ-ACK information bits for candidate PDSCH reception occasions of each cell of the first set of cells and the second set of cells, and a second part comprising at least one HARQ-ACK information bit for one or more PDSCHs among the first set of PDSCHs and the second set of PDSCHs received on one or more cells of the first set of cells and the second set of cells and located out of candidate PDSCH reception occasions of the one or more cells of the first set of cells and the second set of cells.

13. The UE of claim 8, wherein to generate the HARQ-ACK codebook, the at least one processor is further configured to cause the UE to, to generate HARQ-ACK feedback for each cell of the first set of cells and the second set of cells, which comprises:
a first part comprising HARQ-ACK information bits for candidate PDSCH reception occasions of a corresponding cell of the first set of cells and the second set of cells; and
a second part comprising at least one HARQ-ACK information bit for a first PDSCH of the first of PDSCHs and the second set of PDSCHs in response to the first PDSCH being received on the corresponding cell and located outside of the candidate PDSCH reception occasions of the corresponding cell.

14. The UE of claim 1, wherein the first DCI format includes a first indicator indicating separate slot level offset for each of the first set of PDSCHs with reference to the slot where the first DCI format is received, and a second indicator indicating the slot where the HARQ-ACK codebook is transmitted with a restriction that the first set of PDSCHs is included in the candidate PDSCH reception occasions on associated cells of the first set of cells, and the HARQ-ACK feedback for the first set of PDSCHs is included in the HARQ-ACK feedback associated with candidate PDSCH reception occasions on the first set of cells.

15. A base station (BS) for wireless communication, comprising:
at least one memory; and
at least one processor coupled with the at least one memory and configured to cause the BS to:
transmit, to a user equipment (UE), a first downlink control information (DCI) format scheduling a first set of physical downlink shared channels (PDSCHs) on a first set of cells of the UE; and
receive, from the UE, a hybrid automatic repeat request acknowledgement (HARQ-ACK) codebook comprising HARQ-ACK feedback associated with candidate PDSCH reception occasions on the first set of cells and HARQ-ACK feedback for the first set of PDSCHs.

16. A method performed by a user equipment (UE), the method comprising:
receiving a first downlink control information (DCI) format scheduling a first set of physical downlink shared channels (PDSCHs) on a first set of cells;
generating a hybrid automatic repeat request acknowledgement (HARQ-ACK) codebook comprising HARQ-ACK feedback associated with candidate PDSCH reception occasions on the first set of cells and HARQ-ACK feedback for the first set of PDSCHs; and
transmitting the HARQ-ACK codebook.

17. The method of claim 16, wherein generating the HARQ-ACK codebook further comprises generating HARQ-ACK information bits for each cell of the first set of cells and concatenating the generated HARQ-ACK information bits for each cell of the first set of cells in order of associated serving cell index.

18. The method of claim 16, wherein the HARQ-ACK codebook comprises a first part and a second part, and generating the HARQ-ACK codebook further comprises generating the first part comprising HARQ-ACK information bits for candidate PDSCH reception occasions of each cell of the first set of cells, and generating the second part comprising HARQ-ACK information bits for all cells which can be potentially scheduled by the first DCI format with one PDSCH on each cell.

19. The method of claim 16, wherein the HARQ-ACK codebook comprises a first part and a second part, and generating the HARQ-ACK codebook further comprises generating the first part comprising HARQ-ACK information bits for candidate PDSCH reception occasions of each cell of the first set of cells, and generating the second part comprising at least one HARQ-ACK information bit for one or more PDSCHs among the first set of PDSCHs received on one or more cells of the first set of cells and located out of candidate PDSCH reception occasions of the one or more cells of the first set of cells.

20. A method performed by a base station, the method comprising:
transmitting, to a user equipment (UE), a first downlink control information (DCI) format scheduling a first set of physical downlink shared channels (PDSCHs) on a first set of cells of the UE; and
receiving, from the UE, a hybrid automatic repeat request acknowledgement (HARQ-ACK) codebook comprising HARQ-ACK feedback associated with candidate PDSCH reception occasions on the first set of cells and HARQ-ACK feedback for the first set of PDSCHs.
